(19) United States
(12) Patent Application Publication
(10) Pub. No.: US 2015/0154684 A1
(43) Pub. Date: Jun. 4, 2015

(54) METHODS AND APPARATUS FOR PROVIDING AUTOMATED EMOTIONAL MOTIVATOR BASED SERVICE

(71) Applicant: Lela, Inc, New York, NY (US)

(72) Inventor: Dmitry Korobkov, London (GB)

(21) Appl. No.: 14/548,258

(22) Filed: Nov. 19, 2014

Related U.S. Application Data
(63) Continuation-in-part of application No. 13/607,757, filed on Sep. 9, 2012.
(60) Provisional application No. 61/905,864, filed on Nov. 19, 2013.
(60) Provisional application No. 61/905,866, filed on Nov. 19, 2013.

(51) Int. Cl. G06Q 30/06; G06Q 30/02

(52) U.S. Cl. CPC G06Q 30/0631; G06Q 30/0269

(57) ABSTRACT

The present invention provides methods and apparatus for assisting a Purchaser in making a decision related to a Purchase. The decision may include which Product or Service will most satisfy a Purchaser in the event that the Purchaser acquires the Product or Service. The assistance is based upon emotional motivators associated with the Purchaser.

### CROSS REFERENCE TO RELATED APPLICATIONS

The present application claims priority as a Continuation in Part application to non-provisional patent application Ser. No. 13/607,757, filed Sep. 9, 2012 and entitled “Methods for and Apparatus for Associating Emotional Motivators with Products”. The present invention also claims priority to Provisional Patent Application 61/905,864, entitled, “Methods and Apparatus for Automated Cross Sale Based Upon Emotional Motivators” filed Nov. 19, 2013, the contents of which are relied upon and incorporated herein. The present invention also claims priority to Provisional Patent Application 61/905,866, entitled “Methods and Apparatus for Automated Messaging Based Upon Emotional Motivators” filed Nov. 19, 2013.

### FIELD OF THE INVENTION

The present invention relates to methods and apparatus for cross selling a customer of a first class of goods and services to a second class of goods and services based upon emotional motivators of the customer. More specifically, the present invention includes computerized apparatus logically connected and programmed to assess a customer's emotional motivators as the emotional motivators relate to a first class of Products and Services and recommending a second Product or Service based upon the automated assessment of the customer's emotional motivators.

### BACKGROUND OF THE INVENTION

In previous related applications, it has been taught to assist a Purchaser by providing assistance to the Purchaser in making a decision as to which Product or Service the Purchaser should select in order for the Purchaser to be satisfied with transaction.

The present invention recognizes that it is also important for a vendor of products and services to have insight into which products and services will satisfy a Customer. A sheer number of choices a Vendor may have as to which products to present to a potential Purchaser, both online and via brick and mortar, may be overwhelming.

Decision making may be further complicated by time constraints faced by a Vendor. Time pressures to make a decision on which Product or Service to purchase make it difficult for a Vendor to conduct detailed research as to which Product or Service to recommend of many available that may be available. As a result, Vendor is often forced into a decision to make a recommendation with little understanding about whether a Purchase of a recommended Product or Service will prove satisfactory to the Purchaser.

Advertisement may be helpful, but does not fully remedy the problem since advertising is almost as much art as it is science. Advertising agencies attempt to ascertain what will appeal to the masses and then position products in a light which it guesses will sell those products. Demographic data is collected and reviewed to study which products appeal to various demographic groups, and advertisement media may be tailored to reach those demographic groups.

Online sales have allowed advertising to evolve and online sellers may now suggest additional products to a user for the user to purchase based upon a purchasing history of the user. The advertising agency and seller may have other data sources to quantify user demand which the advertiser and seller may analyze and study to better position themselves with respect to segments of society that may purchase their goods.

However, there has not existed a tool which allows a vendor who is in communication with a potential Purchaser to understand what motivates the Purchaser on an emotional basis for first Product and use the knowledge to cross sell another product.

### SUMMARY OF THE INVENTION

Accordingly, the present invention provides a Vendor with automated methods and apparatus for providing guidance relating to a purchase, a life event or other decision via an assessment of emotional motivators for a first transaction and utilizing the assessment for a second transaction. In some preferred embodiments the second transaction will include a recommendation of a Product or Service of a different class than a Product or Service for which a first recommendation was made.

The essence of the present invention includes indicating an appropriateness of a decision, such as a purchase, according to which choice of a Product or Service is most likely to satisfy emotional motivations specifically related with the Purchaser.

Preferred embodiments include a programmable processor executing software commands to complete the assessment and recommendation. Options which satisfy emotional motivators of a user, such as a Purchaser, may be ascertained based upon an automated interactive assessment of the user's emotional state.

In some embodiments, the interactive assessment may be provided online and thereby become widely available for use by a Vendor to better understand which Products and/or Services to promote to a Purchaser. The present invention utilizes data quantifying emotional motivators that is gathered to recommend a first product; the data is further utilized to recommend a second product. In some preferred embodiments, the data is used to recommend a second product of a different class than the first product.

In another related aspect of the present invention, an automated apparatus, such as a processing system, receives input data that is descriptive of one or more Products or Services, and associates emotional qualifiers to Products and Services. Emotional qualifiers represent which emotional motivators may be met by a particular Product or Service. In some respects, the Emotional Qualifiers represent a Product Personality. Some embodiments include an association of Emotional qualifiers with “hard” dictionary classifications and “soft” dictionary classifications in the automated apparatus.

A related aspect of the present invention provides methods and apparatus for generating and presenting an interface that facilitates the automated provision of a description of a Product or Service that will make a specific user happy with a choice, such as a purchasing decision. The present invention may also include the provision of a vehicle for consummating a purchase of a recommended Product or Service.

A vehicle for consummating a sale may include, for example, an online sales portal or a brick and mortar store. The interface may be presented on a network access device via a data communication over a distributed network, such as the Internet.

Essentially, the present invention first determines what is important to a user, such as a potential Purchaser and then correlates a decision, such as which product to purchase, with what was determined to be important to the user. In some preferred embodiments, steps directed to determining what is important to the user are based upon “playful” interactive activities engaged in by the user. Other embodiments may include traditional question and answer input.

With these and other advantages and features of the invention that will become hereinafter apparent, the invention may be more clearly understood by reference to the following detailed description of the invention, the appended claims, and the drawings attached herein.

### BRIEF DESCRIPTION OF THE DRAWINGS

As presented herein, various embodiments of the present invention will be described, followed by some specific examples of various components that can be utilized to implement the embodiments. The following drawings facilitate the description of some embodiments of the present invention.

FIG. 1 illustrates a block diagram of a prior art method of steps a Purchaser may take in making a purchase.

FIG. 2 illustrates a block diagram of functional modules that may be used to implement embodiments of the present invention.

FIG. 3 illustrates a block diagram of a purchase process that may be used to implement embodiments of the present invention.

FIG. 4 illustrates a block diagram of decision functions that may be included in some implementations of the present invention directed to a purchase decision.

FIG. 5 illustrates a block diagram of decision functions that may be included in some implementations of the present invention directed to a non-purchase decision

FIG. 6 illustrates a block diagram of functionalities that may be used to implement some aspects of the present invention directed to associating emotional attributes with Products.

FIG. 7A-7C illustrate block diagrams of exemplary user interfaces including functionalities that may be included in a user interface used to implement some embodiments of the present invention.

FIG. 8 illustrates apparatus that may be used to implement some embodiments of the present invention.

FIGS. 9A-9B include flow diagrams of method steps that may be experienced by a Purchaser in some implementations of the present invention.

FIG. 10 illustrates an exemplary relevancy rating system.

FIG. 11 illustrates an exemplary assignment of brand Emotional Qualifier values to a Product within that brand.

FIG. 12A illustrates an exemplary set diagram, wherein logical relations may exist between Emotional Qualifier Sets of different Product Groups.

FIG. 12B illustrates an exemplary table diagram, wherein logical relations may exist between Emotional Qualifier Sets of different Product Groups.

FIG. 12C illustrates an exemplary cross-sell comparison table is illustrated where Emotional Motivator values of a Purchaser or Purchaser group are associated with the Emotional Qualifier values of a known Product.

FIG. 13 illustrates an exemplary processing and interface system for associating Products and Purchasers by comparing Emotional Qualifier values of a Product and Emotional Motivator values of a Purchaser.

FIG. 14A illustrates exemplary method steps for executing the relevancy rating system.

FIG. 14B illustrates exemplary method steps for utilizing a cross-sell relevancy rating system.

FIG. 14C illustrates exemplary method steps for a real time Product recommendation from a salesperson or sales station to a Purchaser.

FIG. 14D illustrates exemplary method steps for business decisions based on the relevancy rating system.

FIG. 15A illustrates exemplary method steps for executing the relevancy rating system.

FIG. 15B illustrates exemplary method steps for a real time Product recommendation from a salesperson or sales station to a Purchaser.

FIG. 15C illustrates exemplary method steps for business decisions based on the relevancy rating system.

### DETAILED DESCRIPTION OF PREFERRED EMBODIMENTS

The present invention provides automated apparatus with processor and executable software, wherein the software is executable upon demand to assess emotional motivators related to making a purchase. For the purposes of this discussion, a “Purchaser” or multiple “Purchasers” include one or more individuals, or a succinctly defined organization. The present invention collects or otherwise receives subjective and objective data and associates the subjective and objective data with emotional motivators. The collected data is digitally stored as a motivator profile which may be applied and built upon in order to assist with subsequent purchasing decisions.

Executable software is operative in conjunction with a processor to execute methodologies that match emotional motivators to purchasing decisions. Emotional motivators may be associated with one or more of: an individual actually making a purchase; a person who will receive a purchased good or service; and with a good or service which may be available for purchasing.

### GLOSSARY

As used herein the following terms will have the following associated meaning:
“Buying Context” as used herein means circumstantial data related to a Purchase.
“Cross Channel” as used herein means related to a first Purchase in a first subject area with a second purchase or other decision in a second subject area.
“Emotional Reasons” as used herein Emotional Reasons means subjective emotional motivators that form a basis for satisfaction following completion of a decision, such as, for example, a decision to make a Purchase.
“Engine” as used herein means an apparatus including a processor that executes a software process to receive one or more inputs, process the inputs, and generate an output based upon the inputs.
“Local” as used herein means in a geographic proximity reasonable to travel in order to complete a Purchase based upon objective and subjective aspects of the Purchase.
“Motivator” as used herein shall mean a factor which influences a sense of success in making a decision.
“Product” for the sake of simplicity in this discussion, as used herein a Product shall mean one or more of: a tangible item, machine or device; an intangible conveyance such as knowledge, know how or data stream; and a Service performed (as defined below).
“Purchaser” as used herein shall mean a person that makes or contemplates making a purchase.
“Service” as used herein shall mean an action performed at the request of a Purchaser.

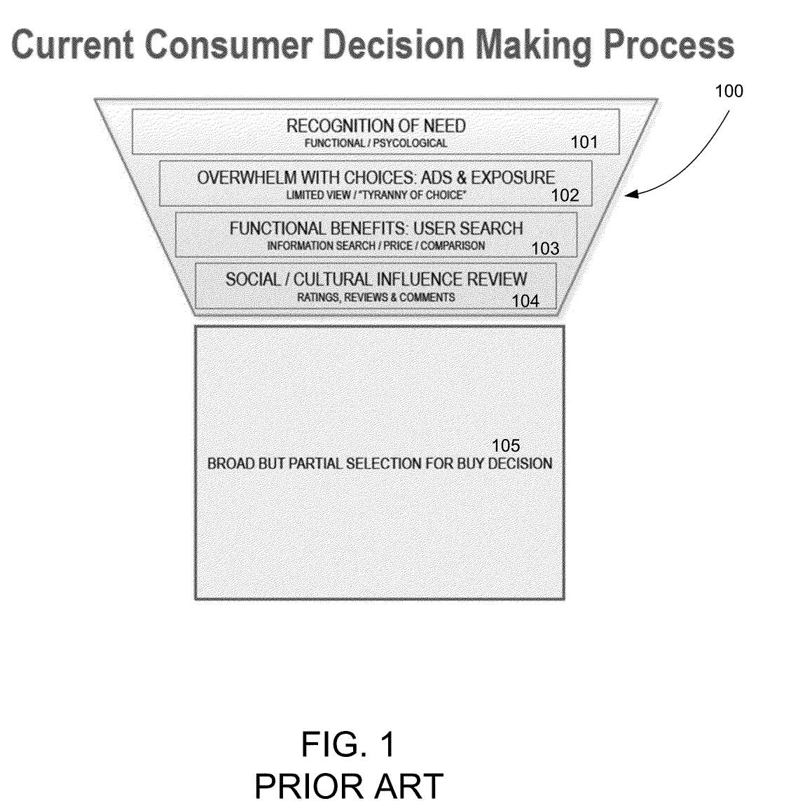

Referring now to FIG. 1, a block diagram illustrates a prior art method for a Purchaser to make a decision to purchase a product or service. At 101, the Purchaser recognizes a need for one or both of: a good and a service. A need may be essentially objective and functional in nature, such as a portion of a defined process, for example a replacement part of a machine, such as an automobile. A need may also be subjective or psychological, such as a need to purchase an item to celebrate an event.

At 102, a Purchaser looking for input may be overwhelmed with choices, advertisements and exposure to media promoting select purchase choices. The view of product and service choices is also limited to those choices that are actively advertised and promoted. At 103, a Purchaser may search functional benefits. The search may reveal information about a product or service, a price and a comparison to other available products. At 104, social and cultural influence may also affect a purchasing decision. The social and cultural influence may include one or more of reviews, ratings and comments descriptive of products.

At 105, the prior art method at best provides a broad amount of information but only partial in regard to a specific purchase event.

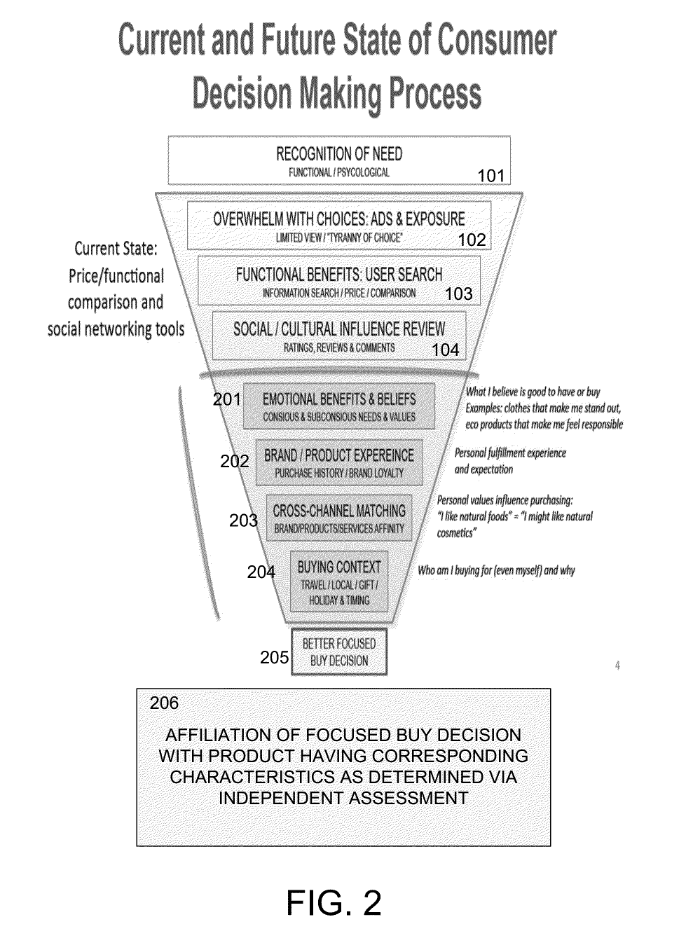

Referring now to FIG. 2, functional steps that may be executed according to the present invention are illustrated. At 201, one or both of emotional benefits and beliefs are assessed.

Emotional benefits and beliefs may be on a conscious or unconscious level and access values inherent in a Purchaser. In some preferred embodiments, discussed more fully below, a Purchaser will provide value related data as input into a computerized apparatus, wherein the data may be processed by a programmable algorithm to correlate the input data with one or more core values useful to make a purchasing decision. Emotional benefits may include, for example, whether a Purchaser believes that it is good to own or to buy Products that make the Purchaser stand out, or whether it is good to own or to buy Products that are ecologically friendly and which make the Purchaser feel responsible.

Another example of an objective need may include a need for a carriage to carry a baby during a jogging activity. A need that is essentially subjective includes a need for a stylish baby carriage that will make the Purchaser appear chic.

At 202, in addition to value based data, the computerized apparatus may include one or both of brand and product experience. A purchase history may also be used, in addition to brand loyalty, or in place of brand loyalty.

At 203, in some embodiments, cross channel matching may be implemented. Cross channel matching includes determining an emotional reason for affinity to a first one or more of: a brand, a Product; and a service. With Cross-Channel matching, one or more Emotional Reasons is stored and made available to be applied to at least a second one or more of: a brand, a Product; and a service. The application of the Emotional Reason to the second one or more of a brand, a Product; and a service, facilitates a recommended choice of purchase of the second brand, Product; or service.

At 204, a buying context may also be considered in making a recommendation of a purchase. A buying context may include, for example, whether the purchase will be: made during travel; from a local vendor (or at least a vendor with a local presence); for a gift for another person; is associated with a holiday; or has specific timing constraints. By way of non-limiting illustration, a buying decision may be for a gift that will be picked up during travel to a particular destination and during particular calendar days. In another illustrative example, a purchase may be for a person supplying emotional Motivators and be for a purchase that will be made local on a same day as purchasing research is conducted.

At 205 a Purchaser is presented with a better focused buying decision. The focus may include a clear representation of who, what, where and when a purchase will be made.

At 206, the present invention correlates a Purchasers Emotional Motivators with a Product having corresponding Motivator characteristics as determined via an independent assessment of the Product (discussed further below).

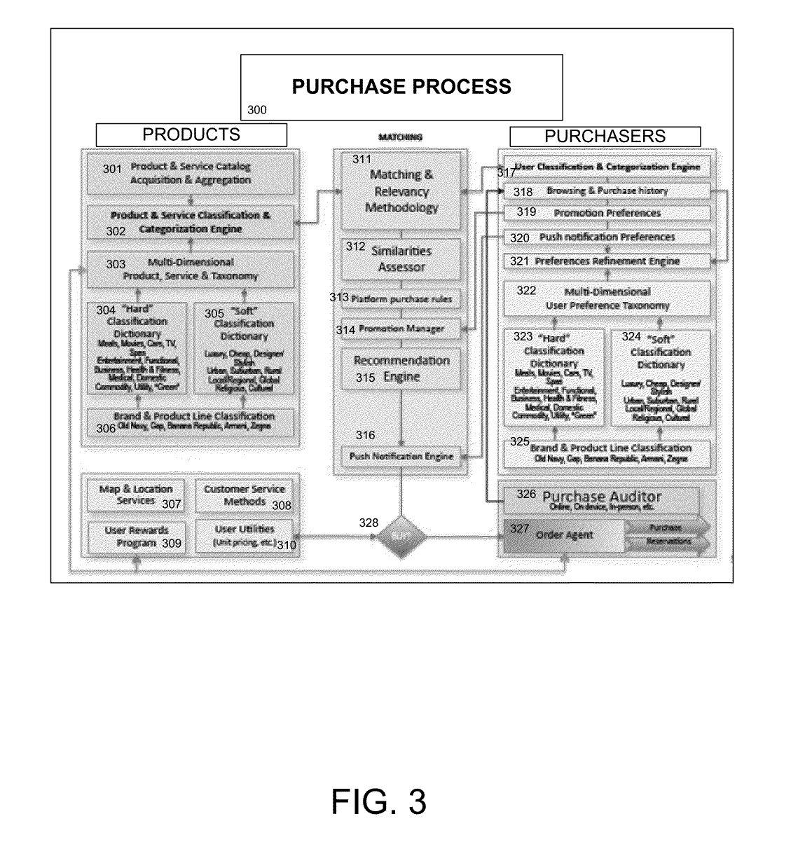

Referring now to FIG. 3, a process is presented according to some embodiments of the present invention. On a high level, the process includes method steps that may be implemented to practice novel aspects of the invention, including, for example, associating Emotional Motivators to Products and Services; associating Emotional Motivators with a Purchaser, and matching one or more Products and Services with a Purchaser. At 301, data is aggregated which is descriptive of one or more Products. The data may include, for example, catalogs, whether physical or virtual with information quantifying aspects of a Product.

At 302, the aggregated data is input into a Product and Service Classification and Categorization Engine. In essence, the engine is a computerized apparatus with programmable code. The programmable code is executable upon demand to parse, sort and link various aspects of the aggregated data according to one or both of predefined taxonomies and relationships and taxonomies and relationships “grown” as a result of data analysis. For example, it is within the scope of the present invention to associate product data with taxonomies and relationships previously encountered by a Product and Service Classification and Categorization Engine or have the engine create new taxonomies and relationships, based upon aggregated Product data received.

At 303, multi-dimensional data may therefore be generated which includes taxonomy tables relevant to a Product and which excludes taxonomy tables not relevant to a Product. For example, the Product may comprise a child's toy. In such aspects, at 303, the generated taxonomy table may include safety, price, and durability but may exclude popularity among young adults without children.

At 304, in some preferred embodiments, a Categorization and Classification Engine will allocate at least some of the aggregated data into a relatively objective “Hard” Classification Dictionary. A Hard classification may include, for example, one or more of: Meals, Movies, Television, Entertainment, Functional Business, Health, Fitness, Spas, Medical, Domestic, Foreign, Commodity, environmentally friendly or “Green” or other relatively bright line test for inclusion or exclusion on an objective basis.

At 305, additionally, some preferred embodiments may include a Categorization and Classification Engine which allocates at least some of the aggregated data into a relatively subjective “Soft” Classification Dictionary. A Soft classification may include, for example, one or more of: luxury, cheap, designer, stylish, urban, suburban, rural, local, regional, global, religious, cultural or other taxonomy or classification which is essentially relative to other taxonomies.

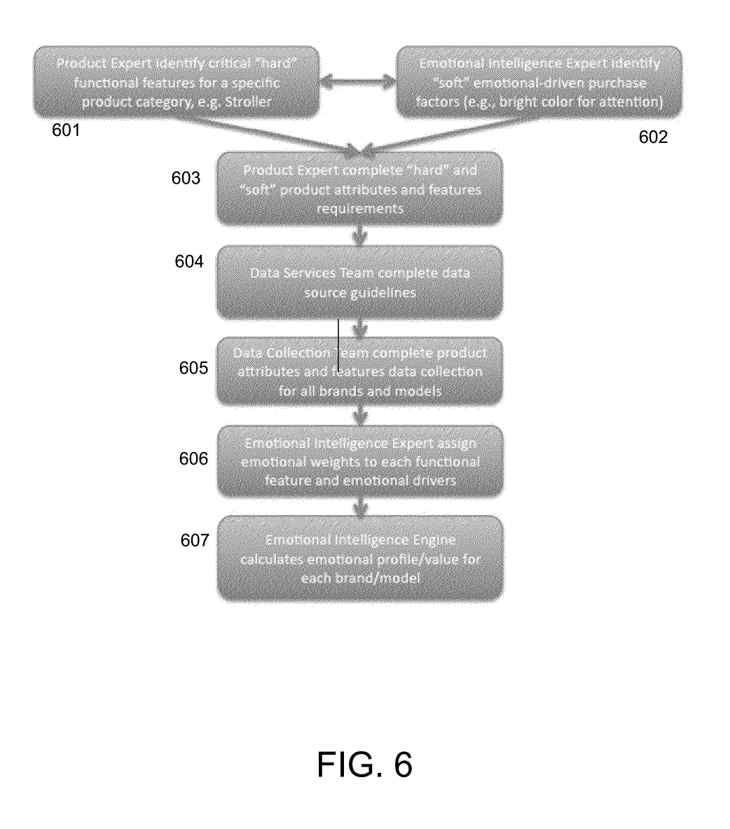

In some aspects, the Soft classifications may be derived from comparing emotional triggers associated with Product attributes, Purchaser feedback, and Product specifications to those of other Products in similar categories. For example, a Product may be defined as luxurious comparative to another similar Product. Alternatively, the Soft classifications may be predefined by experts, such as illustrated in FIG. 6.

At 306, some exemplary embodiments may also include recognition of a brand associated with a Product. The brand may include a trademark or other designation that associates a Product with a manufacturer or service provider. It is preferable that the brands also be associated with the taxonomies and classifications included in the hard Classification Dictionary and the Soft Classification Dictionary.

At 307-310, additional considerations that may be included in a presentation to a Purchaser of a Product suitable to the Purchaser are illustrated. Additional considerations may include, for example, at 307, a map with an indication of where a Product or Service is available. In some embodiments, a location of a Product or Service may be shown relative to a location of an interested Purchaser. At 308, customer service methods, conditions, and terms may also be a considered taxonomy. At 309, a rewards program along with the conditions and terms of the program may be in included taxonomy. At 310 user utilities that may also be an included Taxonomy.

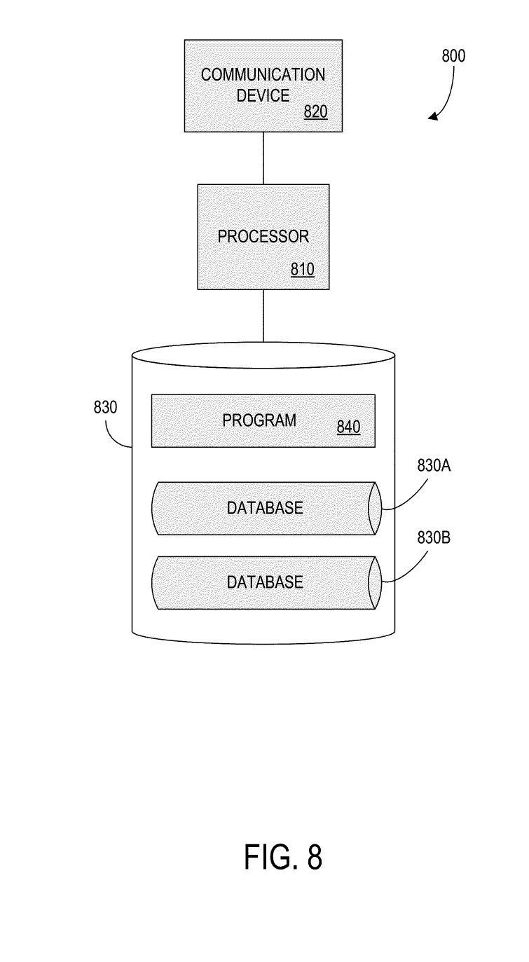

A matching engine may include automated apparatus, such as illustrated in FIG. 8, including a processor, a digital storage device and executable software stored on the digital storage and executable upon command to match Products which may include goods and services with Purchasers. At 312, a Similarities Assessor may include executable code for associating Emotional Qualifiers with products and Emotional Motivators with users and base similarities of one or both based upon the associations. A Platform Purchase rules module 313 may be used to quantify the logistics of making a purchase for a particular platform on which the resent invention is implemented. For example, an online website may of a first set of Platform Purchase rules 313 and an in store kiosk may include a second set of Platform Purchase rules 313.

In some embodiments, a Promotion Manager 314 may be included for promoting one or more of: a brand, a vendor, a product and a service. Promotion may include interactions with a user via a graphical user interface. A Recommendation Engine 315 is functional to make a Purchase recommendation to a Purchaser based upon the method steps of the present invention. A Push notification engine 316 may be utilized in some embodiments to provide push services to a user, such as a Purchaser of Product related information, such as, for example, availability of a Product, a price of a Product, a promotion of a Product, or other information.

Considering now a Purchaser and taxonomies and data that may be input indicative of the Purchaser's Emotional Motivators, items 318-327 include various aspects of data that may be included by a user categorization and classification engine (sometimes referred to herein as “CC Engine”) 317 practicing the method steps of the present invention. In some exemplary embodiments, the data and classifications utilized by the CC engine 317 may be categorically similar to the data and classifications used to determine Emotional Qualifiers of a product. Such embodiments may allow for a more direct correlation between Emotional Qualifiers and Emotional Motivators.

As defined herein a Motivator may include for example, one or more of: a need for physical safety and emotional security; a need for acceptance (and approval), the need to belong to the group; a sense of self-worth and the need to have others validate one's worth; a need for attention (and the need to attract attention) from others; a need for acknowledgment and approval from those in authority; a need for physical affection and comfort; and a need to control money or other manifestation of material abundance.

At 318, the CC engine 317 may receive and process data indicative of one or both of a browsing history and a purchasing history of a Purchaser. A CC Engine 317 may receive and process data indicative of one or both of: promotion preferences of a Purchaser 319; and push notification preferences of a Purchaser 320. At 321, a Preferences refinement engine may correlate various Purchaser preferences and generate preference trends for a Purchaser. The Purchaser trends may be included in a multi-dimensional Purchaser preference taxonomy or other user preference taxonomy, generated by a computerized device implementing the present invention.

At 322, a multi-dimensional user preference taxonomy may be employed which includes input from a Product hard classifications dictionary 323 and a Product soft classifications dictionary 324. The Product hard classifications dictionary 323 may include, by way of non-limiting example, one or more of: Meals, Movies, Television, Entertainment, Functional Business, Health, Fitness, Spas, Medical, Domestic, Foreign, Commodity, environmentally friendly or “Green” or other relatively bright line test for inclusion or exclusion on an objective basis.

The Product “Soft” Classification Dictionary 324 may generally include by way of non-limiting example, one or more of: luxury, cheap, designer, stylish, urban, suburban, rural, local, regional, global, religious, cultural or other taxonomy or classification which is essentially relative to other taxonomies.

Product and brand classification may also include recognition of a brand associated with a Product. The brand may include, for example, a trademark, service mark, or other designation that associates a Product with a manufacturer or service provider. It is preferable that brands also be associated with taxonomies and classifications included in the hard Classification Dictionary and the Soft Classification Dictionary.

Classification systems may also include brand and Product classifications 325. Product and Brand classification may, for example, include associations of Emotional Qualifiers with Products and/or Brands, wherein the Products and Brands may thereby be associated with Emotional Motivators via the Emotional Qualifiers.

A Purchaser may make a decision to execute a “Buy” action 328 and make a purchase. An order agent 327 may be used to implement a purchase instruction associated with a Buy 328 action. As discussed further below, a Buy action 328 may be communicated to a computerized system via a user interactive device. The user interactive device may be any apparatus that is functional to interface between a human and a computerized system. The user interactive device may therefore include, for example, one or more of: a keyboard, mouse other pointing device, touchscreen, auditory voice command, neural interactive device or other apparatus.

The Order Agent 327 may essentially function as an interface between a user instruction and a purchase or reservation system or module. The Order Agent 327 will provide data to a purchase or reservation system or module sufficient for the purchase or reservation module to execute the Purchase instruction.

In another aspect of the present invention, a Purchase Auditor module 326 may track or audit purchases made by a Purchaser, or group of Purchasers (trending). The Purchase Auditor function may provide analysis of purchasing activity and plot any trends that may be present within data of a Purchaser or group of Purchaser's history. Accordingly, at a first given time period, a Purchaser may be primarily motivated by a first set of Motivators which are based upon a first set of Emotional Reasons. During a second time period, a prevalence of a second set of Emotional Reasons may emerge.

For example, during a first time period, a Purchaser may be primarily motivated by an Emotional Reason of wanting to be stylish or chic. This may correlate, with a period of financial success and significant social interaction. During a second time period, a Purchaser may be primarily motivated by an Emotional Reason of seeking high quality and durability. This period may correlate with a period of financial challenge and focus on raising a family, or other caregiving.

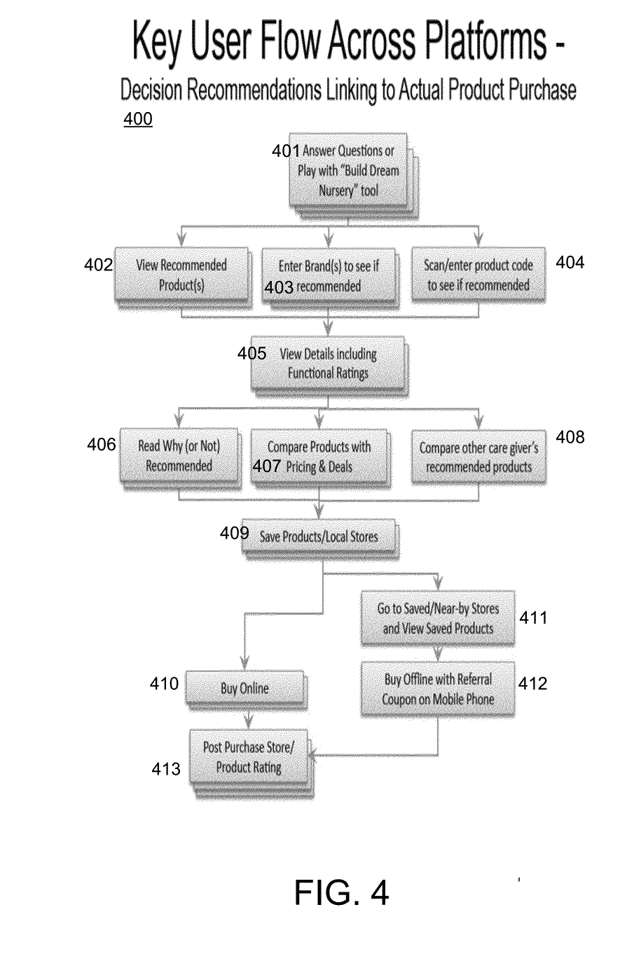

Referring now to FIG. 4, a block diagram illustrates a flow of key user functions across computerized apparatus platforms that may be implemented to facilitate a Purchaser's decision to make a Product purchase. As with other functional modules described herein, the key user functions may be implemented on a computerized device via executable software, executed upon demand. At 401, a Purchaser or other user, may provide input which may be used as input into a Motivator engine to determine primary Emotional Reasons the Purchaser will use to make a Purchase. The input may include, for example, answering questions presented to them about seemingly unrelated choices, or “playing” with an interactive virtual reality scene, such as a “Build a Dream Nursery” tool.

At 402, a computerized system implementing the present invention may allow the Purchaser to view Products which are recommended, based upon input received from the Purchaser. At 403, a Purchaser may also designate a Purchaser preferred brand and the system may indicate if the Purchaser preferred Brand is included in a list of recommended Products.

At 404, a Purchaser may also scan a UPC code or another product identifying code and input the code into the system. The code may be accessed, for example while the Purchaser is shopping in a brick and mortar type store, or at some other time when the Purchaser is observing a Product, such as, for example, when examining a product purchased by a friend. The system may also provide a response indicating whether the scanned item is a recommended item.

At 405, a Purchaser may view details including functional ratings of Products being considered by the Purchaser. The details and ratings may be compiled from multiple sources, including, for example, manufacturer specifications, independent reviews, online blogs, government agencies, ratings entities, or other source.

At 406-408, a Purchaser may receive feedback related to Products of interest to the Purchaser. At 406, feedback may include, for example, why a Product is recommended, or not recommended. At 407 relative prices and purchasing deals for recommended Products may be compared. At 408, Products recommended by other Product users, such as one or more other care givers may also be provided to the Purchaser.

At 409, in some embodiments, a Purchaser may communicate with a store, such as a brick and mortar establishment via a communications network, such as the Internet. Communication with a local store may allow the Purchaser to check inventory of the store for a preferred Product. In addition, in some embodiments, a Purchaser may reserve or save a desired Product at the local store so that the Purchaser may go to the store and review the Product.

At 410, a Purchaser may complete a purchase of a Product online via a virtual storefront, or a virtual exchange. At 411, a Purchaser may physically visit a store and view Products the Purchaser may potentially purchase. At 412 Purchaser may also make a Purchase in the local store. At 413, a Purchaser may provide to a Purchasing system feedback, such as a rating or other indication of the Purchaser's satisfaction with a purchased product or the suitability of a particular product for a purpose. In some embodiments, where the Purchaser may purchase a Product against recommendation, one or both the Emotional Qualifiers of the Product or the Emotional Motivators of the Purchaser may be adjusted, for example, based on the feedback.

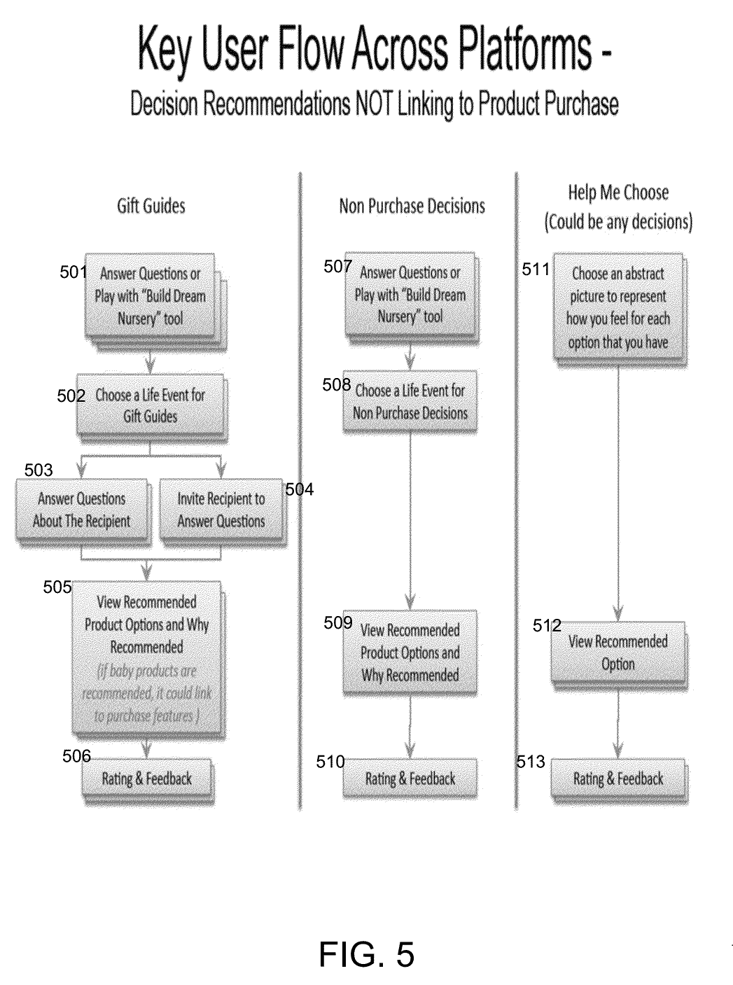

Referring now to FIG. 5, a block diagram illustrates a flow of key user functions across computerized apparatus platforms that may be implemented to facilitate purposes other than a Purchaser's decision to make a Product purchase. At 501-506 steps are illustrated which allow the present invention to be implemented in situations where a Purchaser is making a Purchase for a gift. At 501, a Purchaser may answer interview questions. In some embodiments, answers to questions are gleaned from an interactive activity. The interactive questions may be presented as a virtual game or a virtual tool. For example, one interactive activity may include a virtual “Build a Dream Nursery” activity. A Purchaser, or in some embodiments, a gift recipient or other relevant person, is encouraged to virtually create a nursery. The present invention, allows a computerized apparatus to track selections made in attributes of the nursery. The attributes chosen may be utilized in lieu of, or in addition to, answers to questions from the Purchaser or other user.

As part of input to an eventual Product recommendation for a given circumstance, at 502, a life event may be chosen for a gift guide. At 503, a Purchaser, or other user may provide answers about a gift recipient. The answers may be submitted to a computerized device via any known user interactive tool. At 504, in addition, in some embodiments, a gift recipient may be invited to provide answers to questions. For example, a gift recipient may be sent an electronic communication, such as one or more of: an email, a text, and a social media posting. The gift recipient may follow instructions included in the electronic invitation to a website which allows the gift recipient to identify themselves and answer the questions.

At 505, the present invention allows for one or both of the Purchaser (gift giver) and the gift recipient to view information in a human readable form that is descriptive of recommended Products. In some embodiments, the Purchaser and gift recipient are also provided with information descriptive of why one or more particular Products are recommended. At 506 one or both of the Purchaser and the gift recipient are provided with a user interactive interface for providing a rating on a Product and other feedback on one or more of: a Product; the recommendation; and the emotional motivator process for making recommendations.

In another aspect of the present invention, it is noted that an automated system which uses Emotional Reasons and Motivators to assist in decision making is not limited to decisions relating to potential purchases. Almost any decision may be assisted with an understanding and application of knowledge relating to underlying emotions and motivators.

At 507, a user may undertake one or more activities, such as answering questions or participating in a virtual activity. The virtual activity may include, for example, a game or a tool which provides queries to a user for instructions on how to create something online. At 508, in some embodiments, a life event may be associated with a non-purchase decision which will be made by a user. At 509, the user may view recommendations based upon the input received by, or about, the user, such as obtaining a graduate degree or having children. The recommendations may include, for example, one or more of: a recommended action step, or course of action; a Product selection; and a collaboration with a particular person or group of people. At 510, a user interactive interface may also be utilized for providing a rating or feedback related to the services and recommendations.

At 511, in a still broader, or more high level, implementation, a user may be asked to choose abstract picture or image which represents how a user “feels” or emotionally responds to one or more options presented to the user. At 512, the user or other party (such as a care taker, friend or employer) may view a recommended option. At 513, one or more of the user and another interested party (such as a care taker, friend or employer) may provide rating and feedback information.

Referring now to FIG. 6, a block diagram illustrates how the present invention utilizes assessments of Products, and associates Products, with both “hard” functional attributes and “soft” emotional attributes.

At 601, the present invention receives input from one or more Product Experts which identify critical “hard” functional features for specific products category, such as, for example a baby stroller, an electronic device, a backpack, or almost any other Product. A hard functional feature may include for example, almost any empirical data, and may therefore include, for example, specifications, power ratings, physical dimensions, or other verifiable fact.

At 602, the present Emotional Intelligence Expert identifies one or more “soft’ emotional-driven purchase factors. For example, a Product with a bright color may be associated with an emotional need for attention, a Product with rugged features and durability may be associated with a need to appear masculine. The soft features may be obtained from a database of available features and how those features may translate into, and evoke human emotions.

At 603, a Product Expert may complete a combination of hard and soft product attributes and feature requirements for a Product desired by a Purchaser or other user. At 604, a data services team may provide data source guidelines for a Product. The data source guidelines may include the data fields and definitions for datum that will be compiled for particular product groups. The data source guidelines will serve as an indication of which data fields should be collected for a particular Product, or Product group.

At 605, a data collection team may be tasked with providing the data fields specified by the Product Experts. The data collection may aggregate an input data values into a database which is made available to various engines to facilitate Product selection based upon Motivators and Emotional reasoning.

At 606, in some preferred embodiments, emotional weights are assigned to at least some, if not all of the functional features and emotional drivers. One natural choice is to have one or more emotional intelligence experts assign weights to functional features, and weights to emotional drivers. A weight may include, for example, an alpha numerical value that is associated with a relative scaled value. Other ratings or weights are also within the scope of the present invention, such as, for example, a color coded value.

At 607, in some preferred embodiments, an Emotional Intelligence Engine calculates a value which is associated with an emotional profile for a Product. The value associated with an emotional profile is preferably stored in a data structure which allows the value to be retrieved upon demand. The value may include multiple dimensions. For example, the value may include a scaled indication of an appearance of fiscal status, such as, for example, the brand name Louis Vitton™ may represent wealth, another emotional value may provide an indication of durability, another emotional value may provide an indication of subtleness or loudness. Other emotional values may be included within the scope of the invention, wherein any emotional value that may be influential in a Purchase decision or other decision at hand may be included.

### Apparatus

The teachings of the present invention may be implemented with any apparatus capable of embodying the innovative concepts described herein. Image presentation can be accomplished via any multimedia type interface. Embodiments can therefore include a PC, handheld, game controller; PDA, cellular device, HDTV or other multimedia device with user interactive controls, including, in some embodiments, voice activated interactive controls.

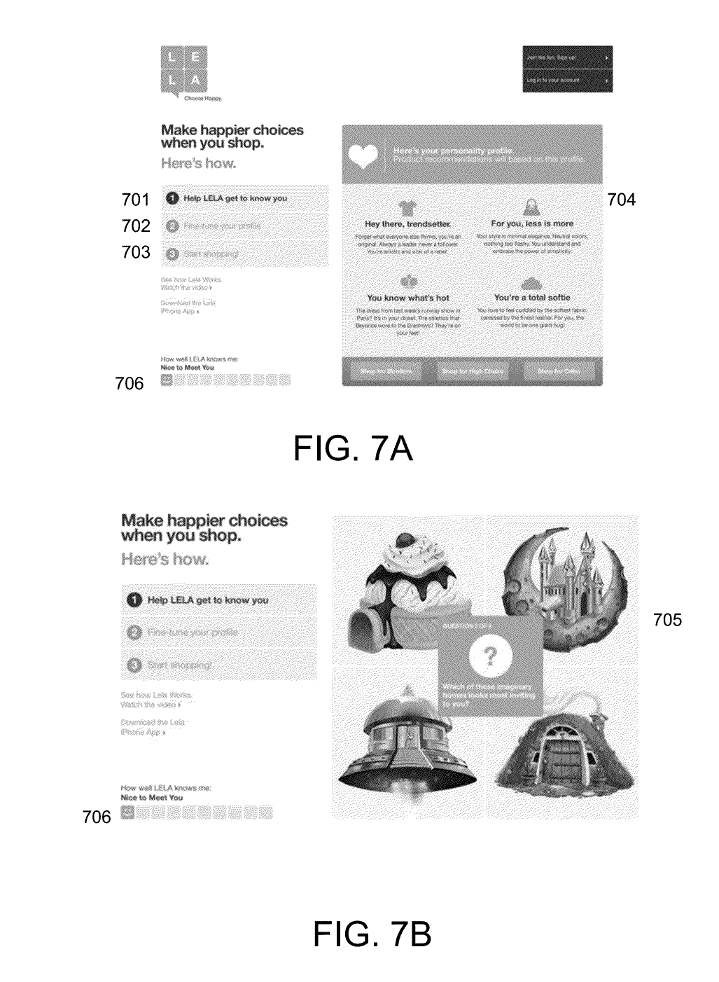

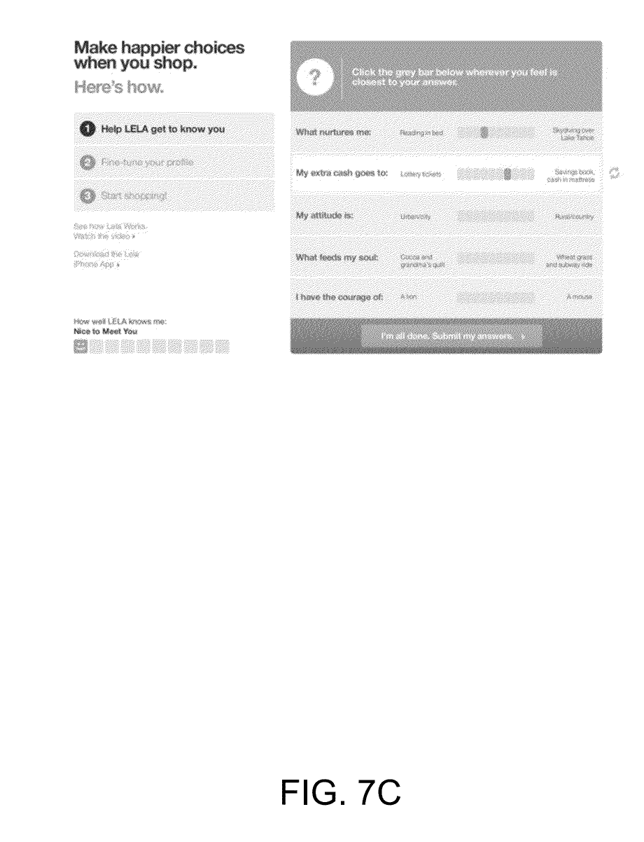

Referring now to FIG. 7A, an exemplary user interactive interface is illustrated. The interface includes multiple user interactive areas which may receive input from a user and provide one or both of human readable content or human recognizable images. Interactive areas may include, by way of non-limiting example, one or more of: a) a user interactive area on a screen that prompts a user of “Help LELA get to know you” 701; b) Fine tune your Profile 702; c) Start Shopping 703.

The Help LELA get to know you interactive area 701 is illustrative of a service such as the LELA™ service. This area 701 may be selected by a user to lead the user through a series of interactive queries designed to educate a LELA software engine about a user. For example, in some preferred embodiments, images may be presented to a user wherein the user is prompted to select one of multiple images in response to one or more questions. In addition, questions may be presented in sentence format and also be used to help LELA “know” the user. In some embodiments, the LELA questions are designed to have the user provide answers that are indicative of one or more emotional motivators that influence the user.

At 702 the user may also be provided with an area that allows the user to “fine tune” or otherwise modify the user profile, including emotional motivators. In some embodiments, a user may use interactive user devices such as icons and prompts to request a new set of images related to a question or to request one or more new questions.

At 703, a user may also choose to begin shopping with assistance of a LELA™ program that relates one or more Products with emotional motivators associated with the user.

At 704, another user interactive area may include an area that provides feedback indicating what Emotional Motivators are associated with the user. At 706, an indicator of how well a user is being serviced by a provider of an interactive interface.

Referring now to FIG. 7B, additional user interactive areas may also include an area that provides an indicator of how well LELA™ knows the user. Essentially, how well LELA™ knows a user may be based upon, for example, one or more of: a number of questions answered by the user a number of images chosen by the user; a number of transactions executed by the user, a browsing history, or other forms of input. As the level on the indicator 706 increases, LELA™ may be able to more accurately provide shopping guidance to the Purchaser.

At 705, a group of exemplary images is presented, wherein each image is indicative of one or more emotional motivators. Selection of an image by a user may provide input to LELA™ Emotional Motivators that may influence a user. At 7706,

Referring now to FIG. 7C, in some preferred embodiments, a user interface that receives input indicating emotional motivators of a Purchaser or other user may include questions that have two questions on a scale, wherein the Purchaser provides a scaled answer along a continuum formed between the two answers. For example, a Purchase may be queried as to what nurtures the Purchaser. Two answers, such as 1) “reading in bed” and 2) “skydiving over Lake Tahoe”. A scale between the two phrases may have a number of positions with some positions closer to the first answer and some positions closer to the second answer and a position equally distant from the first answer and the second answer. A position chosen provides a weighted indication of an answer closest to how a Purchaser feels. As illustrated, multiple questions and weighted answers along respective scales may be provided.

Referring now to FIG. 8, an illustration is provided with a controller 800 that may be embodied in one or more of communications accessible devices and utilized to implement some embodiments of the present invention. Communications accessible devices may include, by way of example, a hand held device such as a cellular phone, a pad device, a personal computer, a server, a personal digital assistant, an electronic reader device or other programmable device.

The controller 800 comprises a processor unit 810, which may include one or more processors, coupled to a communication device 820 configured to communicate via a communication network, such as the Internet, or another cellular based network such as a 3G or 4G network (not shown in FIG. 8). The communication device 820 may be used to communicate with a digital communications network, such as, for example, the Internet available via the Internet Protocol, or a cellular network such as 3G or 4G.

The processor 810 is also in communication with a storage device 830. The storage device 830 may comprise any appropriate information storage device, including combinations of electronic storage devices, such as, for example, one or more of: hard disk drives, optical storage devices, and semiconductor memory devices such as Random Access Memory (RAM) devices and Read Only Memory (ROM) devices.

The storage device 830 can store a program 840 for controlling the processor 810. The processor 810 performs instructions of the program 840, and thereby operates in accordance with the present invention. The processor 810 may also cause the communication device 820 to transmit information, including, in some instances, control commands to operate apparatus to implement the processes described above. The storage device 830 can additionally store related data in a database 830A and database 830B, as needed.

Methods

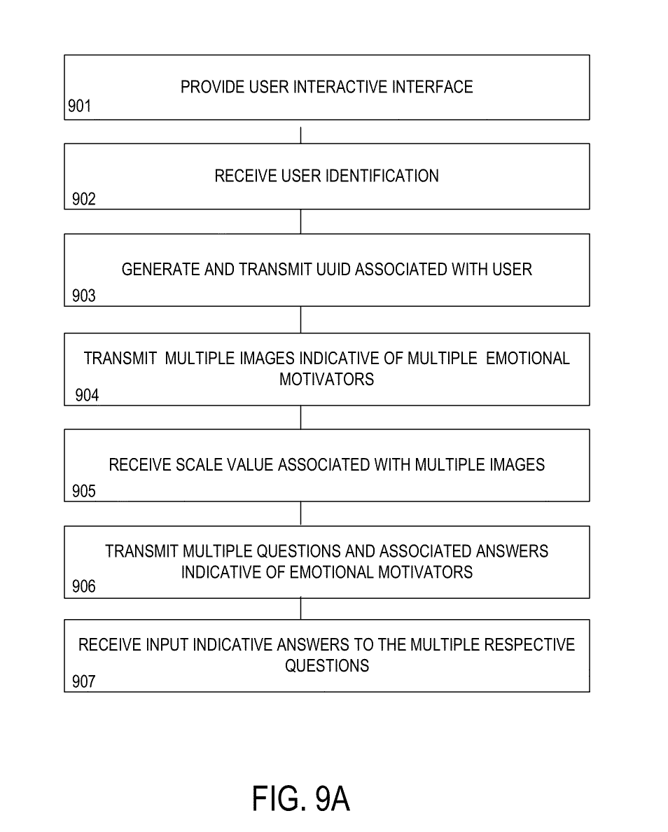

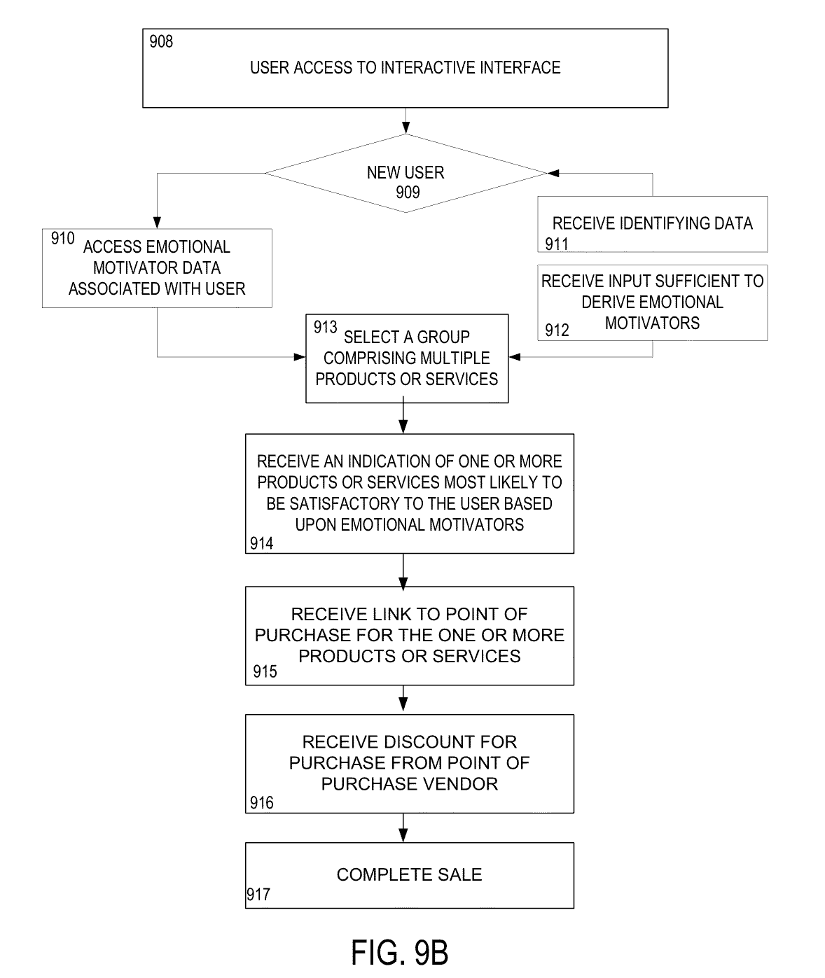

Referring now to FIG. 9A, a flow chart with method steps that may be incorporated into some embodiments of the present invention. The method steps are presented as exemplary and are not required to be executed in a particular order.

At 901, a user, such as a Purchase who is contemplating a purchase for either themselves or for a beneficiary, may access an interactive interface, some preferred embodiments may include access via the Internet or via a mobile phone network, such as, for example, a 3G or 4G network or other cellular or WiFi network.

At 902, the user may provide user identification and at 903 the user may receive a unique identifier, such as, for example in some embodiments, a UUID (universally unique identifier). The UUID may be assigned to a Purchaser, and subsequently acquired Emotional Motivator data from the Purchaser may be associated with the UUID. Such an embodiment may allow a single profile to develop for a Purchaser, which may be used for multiple purchases over multiple Product categories.

At 904, the user may receive a set of multiple images, wherein each respective image is indicative of one or more emotional motivators. At 905, the user may provide input indicative of which image or images represent an answer to a question provided to the user related to the multiple images.

At 906, the user may also receive one or more questions relating to emotional motivators. Questions may be presented, for example via written text or via audio. At 907, the user may provide input indicative of an answer to the multiple respective questions. Answers to the multiple questions will be used to associate emotional motivators with the user.

Referring now to FIG. 9B, additional method steps that may be used to implement some embodiments of the present invention. At 908, a user may access an interactive interface, some preferred embodiments may include access via the Internet or via a mobile phone network, such as, for example, a 3G or 4G network or other cellular or WiFi network.

At 909, the user may indicate whether the user is a new user or already has a profile including emotional motivator data associated with the user. If the user already provided data indicative of the user's emotional motivators, at 910 the system will access the emotional motivator data associated with the user.

If the user is a new user, or for some other reason does not have data associated with the user, at 911, the system may receive user identifying data and at 912 receive input sufficient to associate or otherwise derive emotional motivator motivators with the user.

At 913, the user may select a group including multiple products or services and at 914 the user may receive an indication of one or more Products or Services most likely to be satisfactory to the user based upon the emotional motivators associated with the user.

At 915, the user will receive a link to a point of purchase for the one or more Products and/or Services indicated to be satisfactory to the user. In some embodiments, the point of purchase may be a virtual storefront, or other electronic marketplace or webpage, wherein the Purchaser may complete a purchase of a Product via a linked Internet site. In other embodiments, the point of purchase may include a brick and mortar store. A brick and mortar store may include one or more stores determined to be geographically accessible to the user, such as a brick and mortar store in close proximity to the user, such that the user may reasonably travel to the store and make a purchase. A reasonable travel may be based upon a time and cost of travel in relation to a pecuniary value associated with a related Product purchase.

At 916, in order to entice user to become a Purchaser, the user may receive a discount for Purchase from a point of purchase vendor. The discount may be embodied in the form of a coupon, a rebate, a code, a specific link, or other artifact for conveying discount information. In some preferred embodiments, the discount includes a reference to a provider of a service that processes the emotional motivator data. At 917, the user and/or the vendor may complete the sale.

### Product Block Diagrams

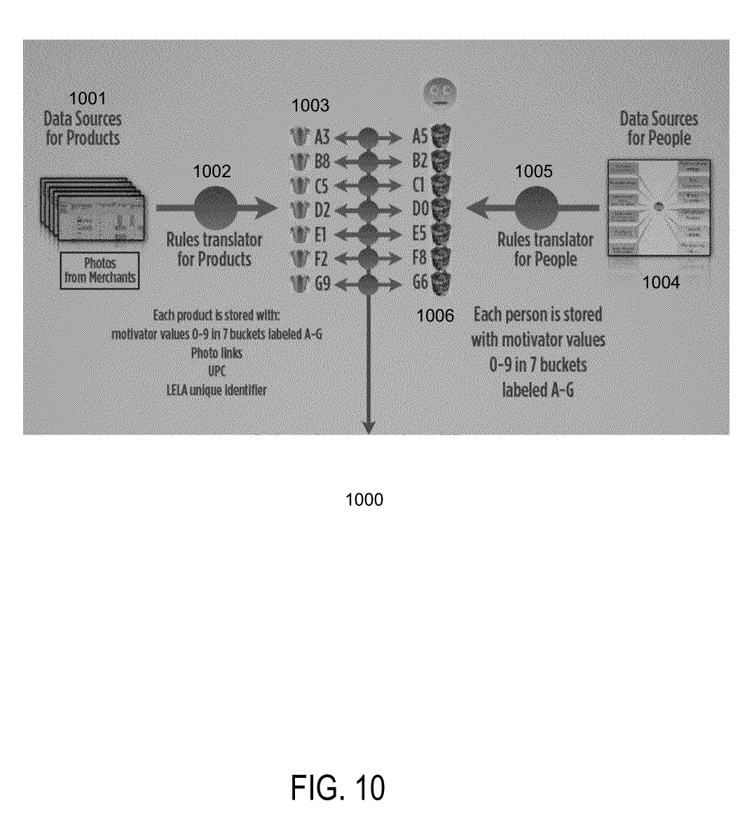

Referring now to FIG. 10, a relevancy rating system 1000 is illustrated, wherein Emotional Qualifier values 1003 of the Product are matched to Emotional Motivator values 1006 of the Purchaser. In some embodiments, a relevancy rating system 1000 may include a computer server or other computerized apparatus and a software engine, wherein the software engine may process data 1001 descriptive of Products and/or Services to associate Emotional Qualifier values 1003. Products may be associated with, for example, a Photo, a UPC Code, an Stock Keeping Unit (SKU) code, or a service provide unique identifier, such as, for example a universally unique identifier code (UUID).

Software additionally matches or otherwise associates Product Qualifiers with Emotional Motivator values 1006 associated with a Purchaser.

In some embodiments, the software engine may extract Product data from a pooled source, which may include, for example, manufacturing specifications, merchant descriptions, and Purchaser feedback. The software engine may apply a rules translator, which may be developed by Product Experts and Emotional Intelligence Experts, such as illustrated in FIG. 6. The relevancy rating system 1000 may select the predefined taxonomy associated with the Product category and assign Emotional Qualifier values to each classification within the taxonomy based on the Product Rules Translator 1002.

The relevancy rating system 1000 may utilize a similar process to evaluate the Emotional Motivators of a Purchaser. In some aspects, the purpose of the relevancy rating system 1000 may be to guide an individual Purchaser to a Product, the data source 1004 may comprise the profile associated with the Purchaser, which may be specified through a UUID, for example. In such embodiments, the relevancy rating system 1000 may apply a predefined Purchaser rules translator 1005 to the Purchaser profile data 1004 to determine the Emotional Motivator values 1006 associated with a Product category.

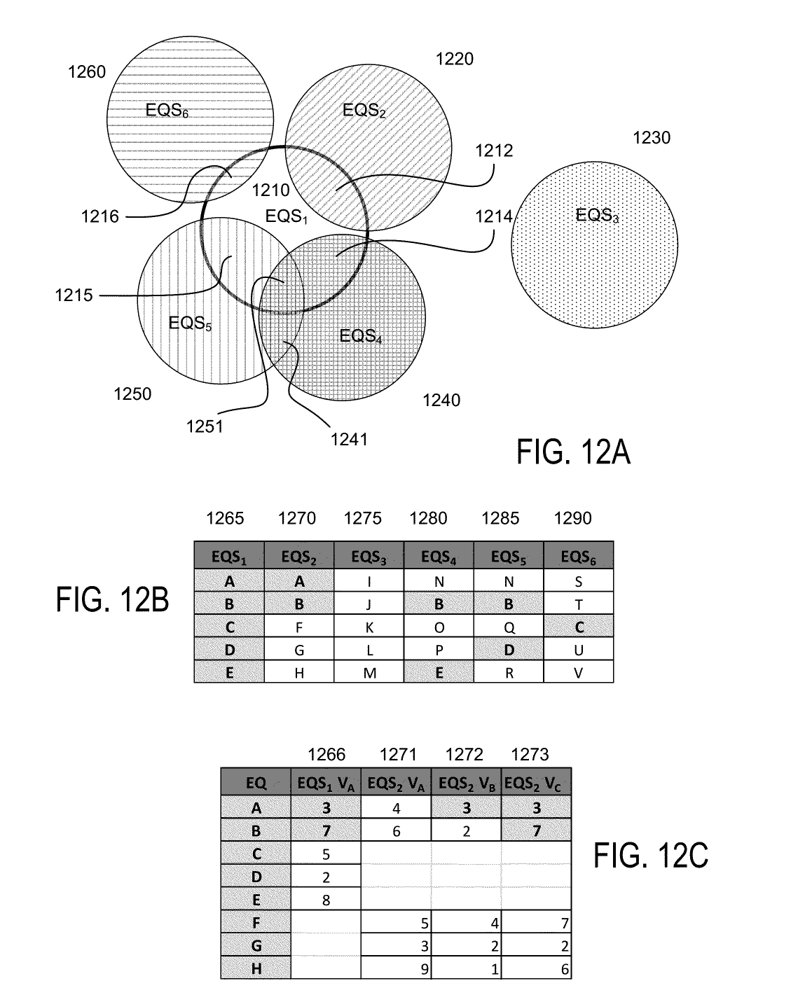

In embodiments where a vendor may provide a network access device, as illustrated in FIG. 12, the vendor may limit results to Products that the vendor may carry. Similarly, a manufacturer, such as a car manufacturer, may limit Products to offerings in their own line of products. In some such examples, the network access device may include Emotional Motivator assessment stations.

Alternatively, in some embodiments, a purpose of a relevancy rating system 1000 may be to assist a manufacturer or merchant to identify a type of Purchaser that may be interested in a product, which may allow the merchant to target groups with a specific demographic profile through strategic advertising. In such aspects, the product data source 1001 may pertain to a particular Product or group of Products, such as Products originating from a particular manufacturer or Products sold by a particular merchant.

In some such embodiments, the relevancy rating system 1000 may extract data from a pool of potential Purchasers, which may include Purchasers who have not purchased within the Product category. A broader source of Purchaser data may allow the merchant to advertise and sell to Purchasers not necessarily on the market for the Product. The relevancy rating system 1000 may assign Emotional Motivator values 1006 to Purchasers based on a predefined Purchaser Rules Translator 1005 to the pool of Purchaser data 1004.

In some embodiments, the relevancy rating system 1000 may rank multiple Products from a single manufacturer or merchant for multiple groups of Purchasers. The rankings may be stored in one or both of the manufacturer or merchant database or Emotional Motivator server, such as illustrated in FIG. 12.

Such aspects may allow an automated system according to the present invention, or a salesperson, to offer Product suggestions to a Purchaser, based on easily acquired and basic Emotional Motivator assessment data from the Purchaser. The Product suggestion may be based on the generalized Product rankings for a group of Purchasers, which may include the present Purchaser. Though the suggestion may not account for detailed Emotional Motivators of the Purchaser, the informed suggestion may instill the Purchaser with confidence in the salesperson. As a result, the Purchaser may be more likely to participate in further Emotional Motivator assessments.

As an illustrative example, the taxonomy for a particular Product type may comprise classifications A through G. The relevancy rating system 1000 may assign an Emotional Qualifier value from 0 to 9 to each classification for a particular Product and may assign an Emotional Motivator value from 0 to 9 to each classification for a Purchaser. In some such aspects, the relevancy rating system 1000 may compare the Emotional Qualifier value set 1003 to the Emotional Motivator value set 1006 to assess the compatibility between the Purchaser and the Product. As illustrated in FIG. 10, the Emotional Qualifier values 1003 may not match the Emotional Motivator values 1006, indicating that the Purchaser may not be compatible or satisfied with the Product.

In some embodiments, such a mismatch may not be presented to the relevancy rating system 1000 user. The processor, such as illustrated in FIG. 8, may store the information in a database, and the result may be filed with the profile associated with the UUID of the Purchaser. As an example, the stored assessment may be presented when a Purchaser chooses the particular incompatible Product, and the processor may explain the reason why the Product may not be recommended, such as illustrated at 406 in FIG. 4.

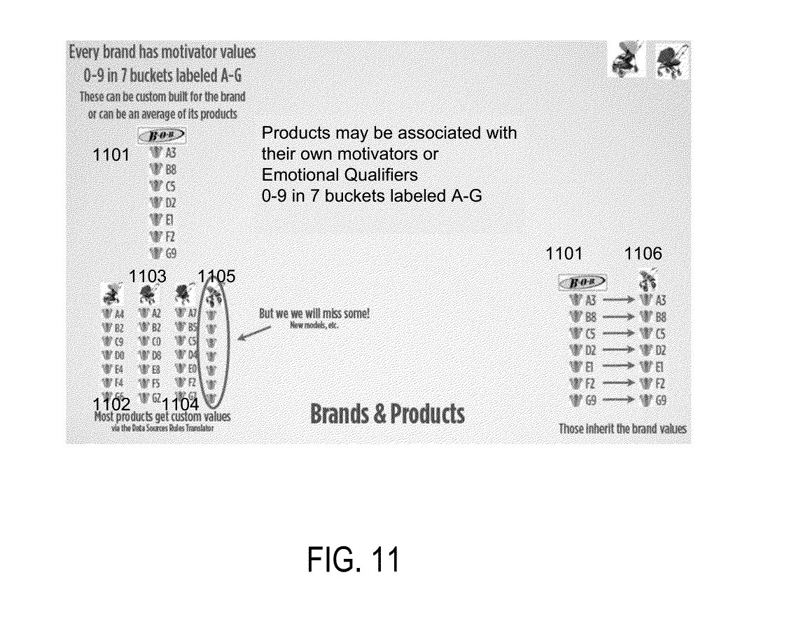

Referring now to FIG. 11, an assignment of brand Emotional Qualifier values to a Product within that brand is illustrated. The large and ever-expanding number of Products available in a particular category may prevent a custom determination of Emotional Qualifier values for every Product. The constraints may be due in part to limited Product data availability, particularly for new or obscure Products. The relevancy rating system, such as illustrated in FIG. 10, may depend on Product data to determine Emotional Qualifier values, and a Product with no data may not be properly assessed. Accordingly, to allow for the inclusion of such Products within the relevancy rating system, a secondary method of assigning Emotional Qualifier values may be necessary.

In some exemplary embodiments, Products within a particular brand may be associated with comparable Emotional Qualifier values. Such values may be averaged or normalized, and the resulting set of Emotional Qualifier values 1101 may be associated, generally, with Products within the defined brand. The value set 1101 may be applied as a default value set for Products within the defined brand, wherein the Product data may be limited or not available, preventing the relevancy rating system from assigning a complete Emotional Qualifier value set 1105.

As an illustrative example, the relevancy rating system may rate strollers based on classifications A through G. Sufficient Product data may be available for three stroller Products to assign Emotional Qualifier values 1102-1104 for each classification. A fourth Product may be available and generally relevant as a stroller Product, but data regarding said stroller Product may be limited and inadequate to assign custom Emotional Qualifier values 1105. In some such embodiments, said stroller Product may be part of a brand that produces other Products, wherein sufficient data may be available on the other Products to establish Emotional Qualifier values.

Based on data from other Products, Emotional Qualifier values 1101 may be assigned to the brand, and the brand Emotional Qualifier values 1101 may be assigned to the stroller Product from that brand. The stroller Product may inherit the brand values 1101, and the relevancy rating system may treat the inherited values as the stroller Product's Emotional Qualifier values 1106. The stroller Product may be included in the relevancy rating system, despite the lack of Product data.

Such embodiments may allow a vendor to provide Purchasers with relevant Product choices based on the entire vendor inventory. Without such brand Emotional Qualifier value adoption, there may be a delay in recommendation for new products until sufficient data exists. Similarly, where a manufacturer may be guiding a Purchaser to a Product within the manufactured line, the brand Emotional Qualifier values may be averaged with similar Products. Such an embodiment may provide some distinction between Products within the line from the same brand, until additional Product data may be available.

Referring now to FIG. 12A, an exemplary set diagram illustrates logical relations that may exist between Emotional Qualifier Sets (EQS) of different Product Groups (PG, numbered 1-6, for illustrative purposes) 1210, 1220, 1230, 1240, 1250, 1260. In some such embodiments, the purchased or known Product may be part of PG 11210, which may be associated with a first EQS. Though referred to as Products and Product groups, services and service groups may also be included in a cross-selling relevancy rating system, wherein the EQS of services and Products may be compared.

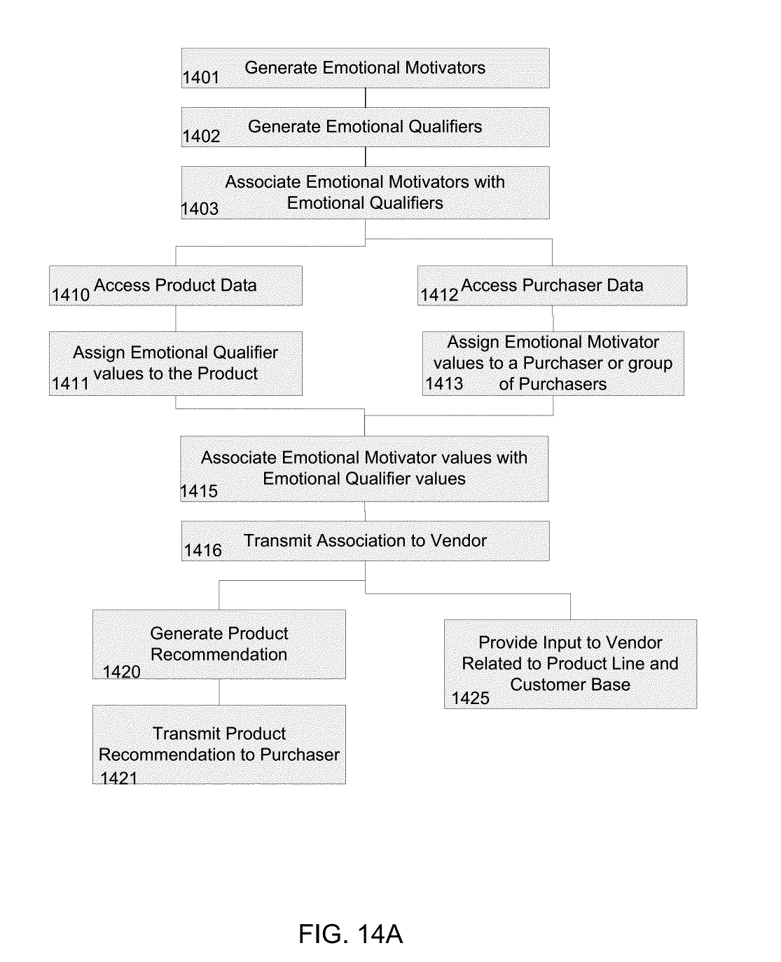

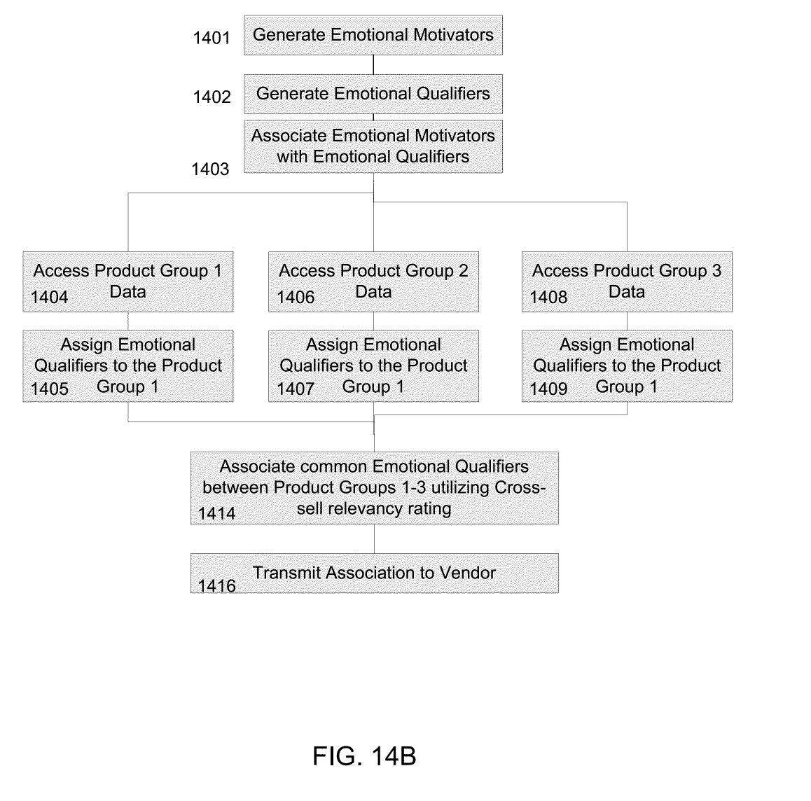

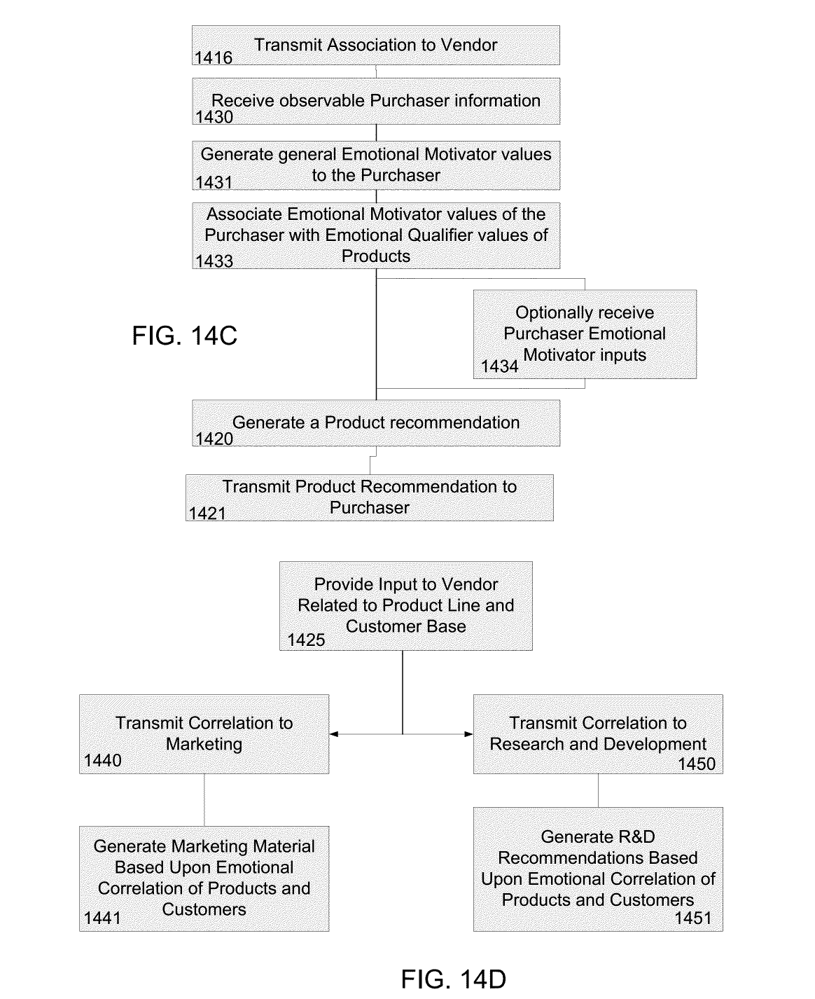

In some embodiments, the cross sell relevancy rating system may activate when a Purchaser purchases or searches for a Product within PG₁ 1210, wherein the system may recommend Products from other PG with similar EQS. Alternatively, the cross sell relevancy rating system may convey association results to manufacturers and vendors, such as described in FIGS. 14A-14C.

In some such exemplary embodiments, EQS₁ 1210 may comprise the Emotional Qualifiers of a known or purchased Product or PG, wherein Emotional Motivators or values of a Purchaser or Purchaser group have been associated with the Emotional Qualifiers or values of said Product or PG. In some embodiments, EQS₁ 1210 may be the basis for cross-sell comparisons, and EQS₂₋₆ may comprise PGs without known Purchaser or Purchaser groups associations. Such aspects may be particularly useful to a vendor or manufacturer as a tool to create marketing and development strategies for a Product that may be new to a market, such as illustrated in FIG. 14C.

Alternatively, the relevancy rating system may establish Emotional Qualifier values and corresponding Emotional Motivator values for more than one PG. In such embodiments, the cross-sell comparison may provide customized Product recommendations, which may be useful to make Product suggestions to a Purchaser, such as illustrated in FIG. 14B.

In some embodiments, a brand may be included in a cross-sell comparison. In some such aspects, the Emotional Qualifiers, not the values, may be more useful in the relevancy rating between multiple Products and brands. For example, PG₂ 1220 may comprise a brand instead of a particular Product or group. In such examples, the EQS may comprise the Emotional Qualifiers of multiple Products or groups within a brand.

Based on the modest overlap 1212, EQS₂ 1220 may represent a Product or PG that a manufacturer may develop to increase the overlap 1212, such as by focusing on those Emotional Qualifiers in one or both PG₁ 1210 and PG₂ 1220. The logical separation between ESQ₁ and ESQ₃ may suggest that PG₁ 1210 and PG₃ 1230 comprise unrelated and irrelevant Products. As an example, the combined overlap 1251 of EQS₅, EQS₄, and EQS₁ may allow a manufacturer or vendor of Products within all three PGs 1210, 1220, 1260 to develop a combined marketing strategy for all three groups based on the overlapping Emotional Qualifiers 1251.

As an illustrative example, PG₁ 1210 may comprise camping tents. The Products in PG₄ 1240 and PG₅ 1250 may be the most relevant, with a separate overlap 1241 between PG₄ 1240 and PG₅ 1250. In some embodiments, Products with significant overlap may be obviously related. For example, PG₄ 1240 may comprise hiking apparel, and PG₅ 1250 may comprise fresh water fishing equipment. A Purchaser interested in camping tents may want hiking apparel to reach the camping destination and may want fresh water fishing equipment to fish at the camping destination (which may be commonly located near a lake or pond).

Products in PG₃ 1230 may be apparently irrelevant. For example, PG₃ 1230 may comprise accounting services. The relevance between PG₁ 1210 and Products in PG₂ 1220 and PG₆ 1260 may be less obvious, and the cross-sell association may be more valuable to vendors and manufacturers. For example, PG₂ 1220 may comprise SCUBA lessons, and PG₆ 1260 may comprise credit cards with travel reward benefits.

Referring now to FIG. 12B, an exemplary embodiment of FIG. 12A is illustrated in table form, wherein the known Product or PG₁ 1265 may be associated with EQS₁ comprising Emotional Qualifiers A-E. The overlap between the EQS of PG₂₋₆ 1270, 1275, 1280, 1285, 1290 is illustrated according to the general logical relation represented in FIG. 12B.

Referring now to FIG. 12C, an exemplary cross-sell comparison table is illustrated where Emotional Motivator values of a Purchaser or Purchaser group are associated with the Emotional Qualifier values of a known Product in PG₁ (EQ₁V_{A}). As illustrated in FIG. 12B, EQS₁ comprises Emotional Qualifiers A-E, and EQS₂ comprises Emotional Qualifiers A, B and F-H. In some such embodiments, Products across multiple PGs may be compared based on the Emotional Qualifiers they may have in common.

As illustrated, for example, three Products from PG₂ may be compared to the known Product in PG₁ by a direct comparison of values associated with Emotional Qualifiers A and B, which the two PGs may have in common. The known Product may be associated with values 3 and 7 for A and B, respectively. Of the three compared Products in PG₂, Product C may be the most relevant to the known Product in PG₁ based on the equivalent values for Emotional Qualifiers A and B. Product B may be somewhat relevant, and Product A may be the least relevant.

The Emotional Qualifier values associated with C-H may not be useful in a cross-sell comparison between PG₁ and PG₂. Alternatively, in some embodiments, a correlation between unique Emotional Qualifiers, such as between D and H, may be developed to allow for more refined cross-sell comparisons between PGs with separate EQS.

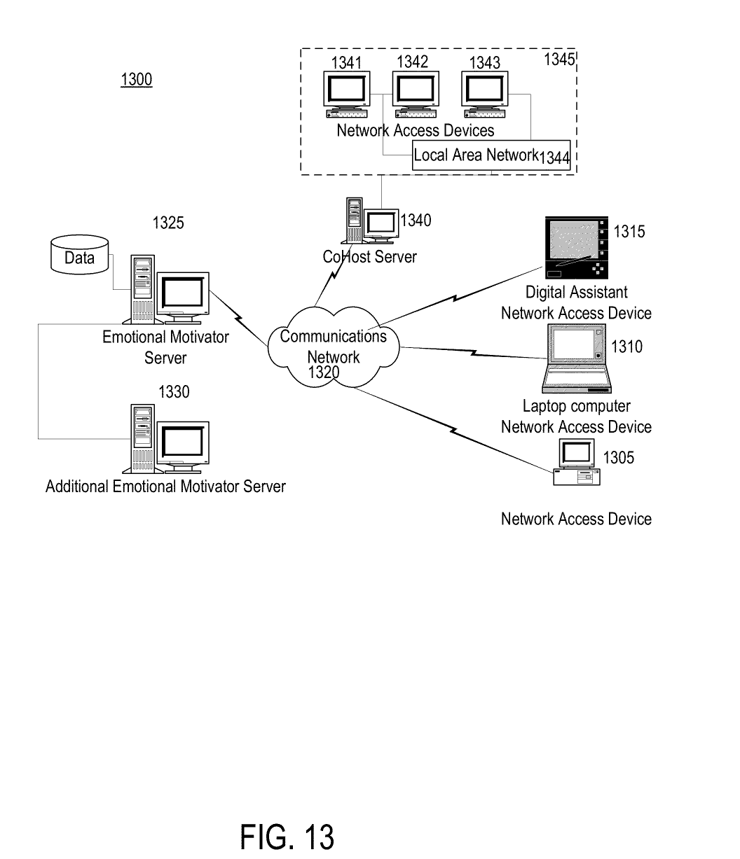

In some embodiments, a Purchaser may initially search (online or in a brick and mortar location) for a Product from PG₁, and the site, network access device (such as illustrated in FIG. 13), or salesperson may recommend a Product from another PG with similar EQS.

In some embodiments, the relevancy rating system may discern between personal purchases and gift purchases. In some such embodiments, the Emotional Motivator values may apply to the recipient of the gift and not the Purchaser, but the values may be based on the Purchaser's perspective of the recipient. Accordingly, the values may not be helpful in determining other relevant Products to the Purchaser, but the Emotional Motivators and Emotional Qualifiers themselves may be useful. The relevancy rating system may apply different Emotional Motivators and/or values for personal Purchasers than for gifting Purchasers.

In some embodiments, the personal questions may be directed separately to the gifting Purchaser and the recipient. For example, the gifting Purchaser may be asked a series of personal questions, such as why she is purchasing a gift. Separately, the gifting Purchaser may be prompted to answer questions based on who she believes the recipient may be. In some embodiments, the system may extract separate Emotional Motivators and values for the gifting Purchaser and the recipient based on multilevel assessment of responses from the gifting Purchaser, without directly asking about the Purchaser.

As an illustrative example, the Product may be newborn baby clothes. Related Products may different for a personal purchase from for a gift purchase. For a personal Purchaser, related Products may primarily include baby necessities, such as diapers and baby wipes. In contrast, related Products for a gifting Purchaser may include other baby gifts or gifts for a new mother, for example.

Referring now to FIG. 13, a processing and interface system 1300 for associating Products and Purchasers by comparing Emotional Qualifier values of a Product and Emotional Motivator values of a Purchaser is illustrated. The system 1300 may comprise a cohost server 1340; Emotional Motivator servers 1325, 1330; and network access devices 1305-1315. The cohost server 1340 may comprise the source for Product data. The Emotional Motivator servers 1325, 1330 may comprise the Emotional Motivator and Emotional Qualifier valuation program and data, wherein the data may include profiles of Purchasers and Products. The network access devices 1305-1315 may allow a Purchaser or salesperson to interface with the system 1300.

In some embodiments, the system 1300 may be linked through a variety of networks. For example, a branch of the system, such as the cohost server 1340, may have a separate communication system 1345, wherein multiple network access devices 1341-1343 may communicate through a local area network (LAN) 1344 connection. The local network access devices 1341-1343 may be internal interface stations, wherein a marketing department or research and development department may access and interface with the Product and Emotional Motivator data. The cohost server may be hosted or monitored by the vendor or manufacturer for example.

The cohost server 1340 may connect to a separate communications network 1320, such as the internet, to access information from the Emotional Motivator and Emotional Qualifier assessment system. The Emotional Motivator algorithms and data may be located in separate server 1325, 1330, wherein the Emotional Motivator Servers 1325, 1330 may be operated by a third party, such as the developer of the Emotional Motivator system.

Similarly, network access devices 1305-1315 may connect to one or both the Emotional Motivator servers 1325, 1330 and the cohost server 1340 through a communications network 1320. The network access devices 1305-1315 may be operated by multiple parties. For example, a digital assistant network access device 1315 may comprise a Product-matching station located at a vendor's brick and mortar location. A laptop computer network access device 1310 may be a personal device owned by an individual Purchaser. Other types of network access devices 1305 may be interfacing systems built into the manufacturing process, for example.

Accordingly, the servers 1325, 1330, 1340 and network access devices 1305-1315 are separate entities for illustrative purposes only. For example, the cohost server 1340 may be operated by a vendor, and the Emotional Motivator servers 1325, 1330 may be integrated into the cohost server communication system 1345. The vendor may also provide a digital assistant network access device 1315 to Purchasers who may visit the store. Alternatively, the vendor may only provide the access device 1315 to Purchasers. In some such aspects, the servers 1325, 1330, 1340 may be operated by a third party or multiple third parties, such as, for example, the manufacturers of the Products carried by the vendor.

The distribution of servers 1325, 1330, 1340 and network access devices 1305-1315, 1341-1343 may be determined by Product marketing tactics. For example, where a manufacturer may be striving to expand its market, the manufacturer may bear the costs of maintaining the servers 1325, 1330, 1340, and provide a digital assistant 1315 to a vendor. As an alternate example, a vendor may want to provide a high-tech shopping experience to Purchasers. Said vendor may be willing to invest in the servers 1325, 1330, 1340 and the digital assistant 1315, for example.

Referring now to FIG. 14A, there are illustrated exemplary method steps for executing the relevancy rating system, such as described in relation to FIG. 10. In some embodiments, the relevancy rating system may comprise a single processor, such as illustrated in FIG. 8. Alternately, the relevancy rating system may comprise a coordinated system of servers and network access devices, such as illustrated in FIG. 13.

As described in relation to FIG. 10, a relevancy rating system may generate Emotional Motivators at 1401 and Emotional Qualifiers at 1402. At 1403, the relevancy rating system may associate Emotional Motivators with Emotional Qualifiers, which may allow for a relevant and meaningful comparison between a Product or Product category and a Purchaser or group of Purchasers.

At 1410, Product data may be accessed, and at 1411, the Product may be assigned Emotional Qualifier values based on the data acquired at 1410. At 1412, Purchaser data may be accessed, and at 1413, the Purchaser may be assigned Emotional Motivator values may be assigned based on the data acquired at 1412. The method steps of evaluating Products, at 1410, 1411, and Purchasers, at 1412 1413, may occur simultaneously or separately.

In some embodiments at 1415, the Emotional Qualifier values may be associated with Emotional Motivator values, wherein the association may provide a correlation between Purchasers and Product preferences. At 1416, the association established at 1415 may be transmitted to a vendor or manufacturer. Based on the transmitted association, at 1420, a Product recommendation may be generated, and at 1421, said recommendation may be transmitted to a Purchaser. Alternatively, at 1425, the transmitted association may provide input to the vendor or manufacturer related to a Product line or customer base, which may be used to optimize marketing and Product development, such as described in FIG. 14D.

Referring now to FIG. 14B, exemplary method steps for utilizing a cross-sell relevancy rating system are illustrated. As illustrated in FIG. 14A, general Emotional Motivators may be generated at 1401, and general Emotional Qualifiers may be generated at 1403. At 1403, the Emotional Motivators may be associated with Emotional Qualifiers.

In some exemplary embodiments, the Emotional Qualifiers of multiple Products or Product groups may be compared to develop cross-sell Product recommendations, such as, for example, illustrated in FIG. 12. In such embodiments, the network system may access data for multiple Product Groups, at 1404, 1406, 1408. Emotional Qualifiers may be assigned separately to each Product Group, at 1405, 1407, 1409. At 1414, the Emotional Qualifiers of each Product or group may be compared by cross-sell relevancy rating, such as described in FIG. 12.

At 1416, the comparison association may be transmitted to a vendor or manufacturer. In some embodiments, the Emotional Qualifier values (such as generated in FIG. 14A at 1412 and 1413) may be compared to develop a more refined Product recommendation. Comparing Emotional Qualifier values may be particularly useful where the Product recommendation is conveyed to a Purchaser, such as illustrated in FIG. 14C.

Referring now to FIGS. 14C and 14D, exemplary method steps for utilizing the relevancy rating system as a sales mechanism are illustrated, wherein the method steps may be a continuation of or additions to the processes described in FIG. 14A. FIG. 14C illustrates method steps for a real time Product recommendation from a salesperson or sales station to a Purchaser, and FIG. 14D illustrates method steps for long-term business decisions based on the relevancy rating system.

At 1416, the association developed in the process steps in FIG. 14A may be transmitted to the vendor. In some embodiments, at 1430, basic Purchaser information may be received. For example, a salesperson may enter observable or easily attainable Purchaser traits, such as, marriage status, sex, age group, and apparel. Based on the simple inputs, at 1431, general Emotional Motivator values may assigned to the Purchaser, wherein the values may place the Purchaser within a Purchaser group.

At 1433, the Emotional Motivator values may be associated with the Emotional Qualifier values of Products sold by the vendor or manufacturer. The Emotional Motivator values may be further refined by additional Purchaser information, and at 1434, Purchaser Emotional Motivator inputs may be received. For example, an interfacing station may allow the Purchaser to engage the “Help LELA get to know you” software engine, such as illustrated in FIGS. 7A-7C.

At 1420, a Product recommendation may be generated, and at 1421, the Product recommendation may be transmitted to the Purchaser, as described in FIG. 14A. In some embodiments, the transmission of the Product recommendation to the Purchaser, at 1421, may be indirect. For example, a salesperson may receive the recommendation and convey the result to the Purchaser. Alternatively, the recommendation may be directed to the Purchaser, such as through an interface station or smartphone application.

Referring now to FIG. 14D, based on the association process illustrated in FIG. 14A, at 1425, information may be transmitted to a vendor or manufacturer related to a Product line or customer base. In some embodiments, at 1440, the Product-Purchaser correlation data may be transmitted to a marketing department, and at 1441, marketing material and tactics may be generated based on said correlation.

In some embodiments, a vendor or manufacturer may advertise on Products with similar or complementary EQS. In some embodiments, a vendor may develop an inventory comprising Products with similar or complementary EQS. A manufacturer may be able to target specific Purchaser groups and develop Products in multiple PG with similar EQS. Often, a manufacturer may have a limited budget to develop a Product or Products. Cross-sell information may be useful to determine how to efficiently allocate the funds to accomplish their business goals.

Where a vendor may have a brick and mortar location, the vendor may design and structure the layout and atmosphere of the store based on preferences of the Purchasers. Cross-sell information may assist a vendor to develop an optimum inventory, wherein a store may be strategically stocked with relevant Products. Such a tactic may allow a salesperson to cross-sell relevant Products within a store to a Purchaser. Similarly, where a Purchaser may be shopping on a network access device, such as illustrated in FIG. 13, a website may be organized to present relevant Products to a Purchaser on a single screen, for example. This may be particularly useful where a Purchaser may add multiple Products to their virtual “cart” from said screen.

In some aspects, at 1450, the correlation data between Emotional Qualifier values of a Product or Product line and Emotional Motivator values of Purchasers may be transmitted to a research and development department. At 1451, research and development tactics and goals may be generated based on said correlation. In some embodiments, the recommendations generated at 1451 may provide a detailed description of how each attribute of the Product contributes to the values of each Emotional Qualifier, which may allow for targeted development.

A manufacturer may focus on developing the attributes correlating to the Emotional Qualifier most closely associated with relevant Products or groups. Such tactics may increase cross-sale of the Product. Alternatively, a manufacturer may develop a Product to focus on the unique Emotional Qualifiers, which may limit cross-sell relevance, but may increase sales within Purchaser groups that may highly value those particular Emotional Qualifiers.

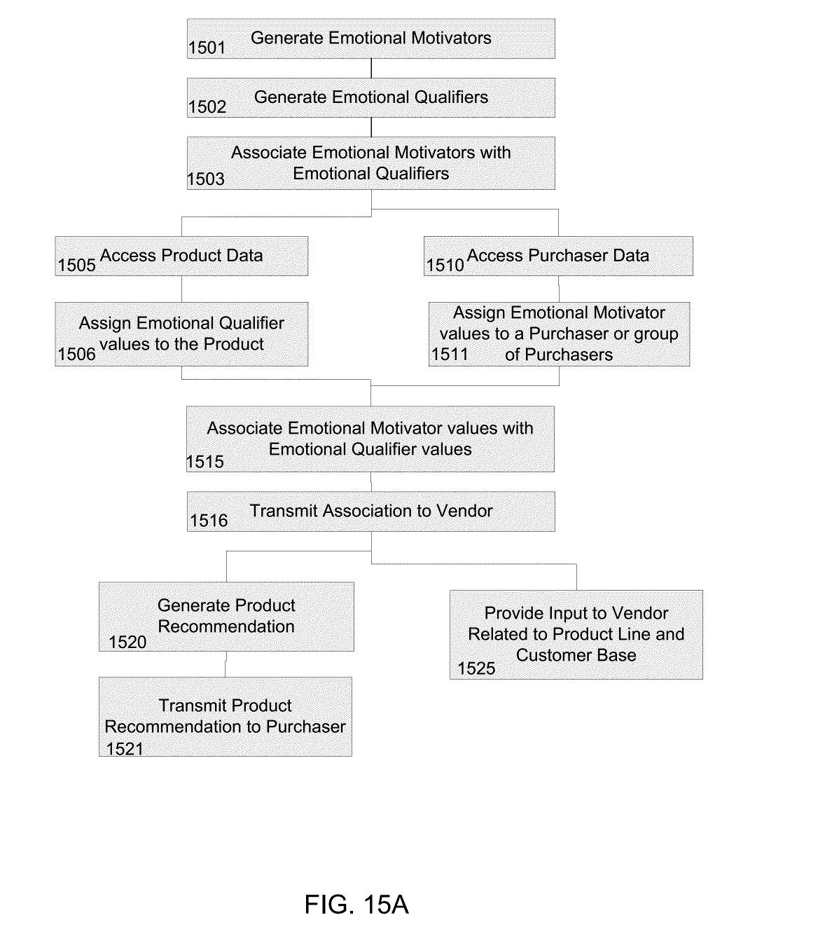

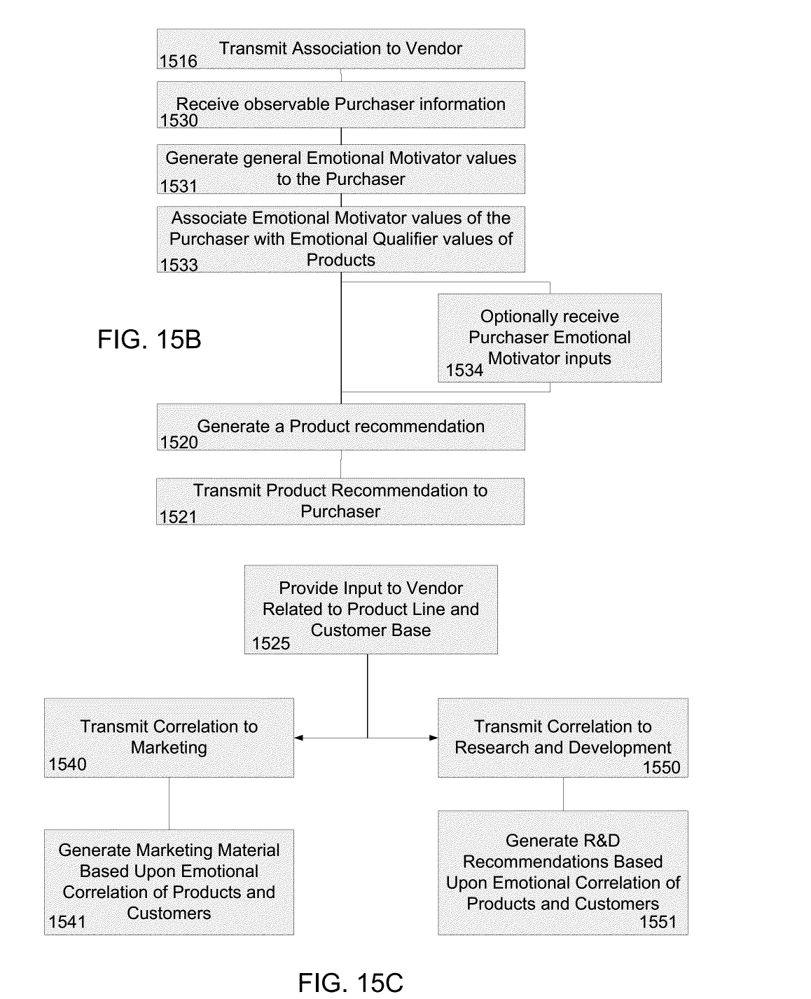

Referring now to FIG. 15A, there are illustrated exemplary method steps for executing the relevancy rating system, such as described in relation to FIG. 10. In some embodiments, the relevancy rating system may comprise a single processor, such as illustrated in FIG. 8. Alternately, the relevancy rating system may comprise a coordinated system of servers and network access devices, such as illustrated in FIG. 12.

As described in relation to FIG. 10, a relevancy rating system may generate Emotional Motivators at 1501 and Emotional Qualifiers at 1502. At 1503, the relevancy rating system may associate Emotional Motivators with Emotional Qualifiers, which may allow for a relevant and meaningful comparison between a Product or Product category and a Purchaser or group of Purchasers.

At 1505, Product data may be accessed, and at 1506, the Product may be assigned Emotional Qualifier values based on the data acquired at 1505. At 1510, Purchaser data may be accessed, and at 1511, the Purchaser may be assigned Emotional Motivator values may be assigned based on the data acquired at 1510. The method steps of evaluating Products, at 1505, 1506, and Purchasers, at 1510 1511, may occur simultaneously or separately.

In some embodiments at 1515, the Emotional Qualifier values may be associated with Emotional Motivator values, wherein the association may provide a correlation between Purchasers and Product preferences. At 1516, the association established at 1515 may be transmitted to a vendor or manufacturer. Based on the transmitted association, at 1520, a Product recommendation may be generated, and at 1521, said recommendation may be transmitted to a Purchaser. Alternatively, at 1525, the transmitted association may provide input to the vendor or manufacturer related to a Product line or customer base, which may be used to optimize marketing and Product development, such as described in FIG. 15C.

Referring now to FIGS. 15B and 15C, exemplary method steps for utilizing the relevancy rating system as a sales mechanism are illustrated, wherein the method steps may be a continuation of or additions to the processes described in FIG. 15A. FIG. 15B illustrates method steps for a real time Product recommendation from a salesperson or sales station to a Purchaser, and FIG. 15C illustrates method steps for long-term business decisions based on the relevancy rating system.

At 1516, the association developed in the process steps in FIG. 15A may be transmitted to the vendor. In some embodiments, at 1530, basic Purchaser information may be received. For example, a salesperson may enter observable or easily attainable Purchaser traits, such as, marriage status, sex, age group, and apparel. Based on the simple inputs, at 1531, general Emotional Motivator values may assigned to the Purchaser, wherein the values may place the Purchaser within a Purchaser group.

At 1533, the Emotional Motivator values may be associated with the Emotional Qualifier values of Products sold by the vendor or manufacturer. The Emotional Motivator values may be further refined by additional Purchaser information, and at 1534, Purchaser Emotional Motivator inputs may be received. For example, an interfacing station may allow the Purchaser to engage the “Help LELA get to know you” software engine, such as illustrated in FIGS. 7A-7C.

At 1520, a Product recommendation may be generated, and at 1521, the Product recommendation may be transmitted to the Purchaser, as described in FIG. 15A. In some embodiments, the transmission of the Product recommendation to the Purchaser, at 1521, may be indirect. For example, a salesperson may receive the recommendation and convey the result to the Purchaser. Alternatively, the recommendation may be directed to the Purchaser, such as through an interface station or smartphone application.

Referring now to FIG. 15C, based on the association process illustrated in FIG. 15A, at 1525, information may be transmitted to a vendor or manufacturer related to a Product line or customer base. In some embodiments, at 1540, the Product-Purchaser correlation data may be transmitted to a marketing department, and at 1541, marketing material and tactics may be generated based on said correlation.

For example, where optimum Purchasers for a particular Product may generally be classed as individuals in households with dual income and no kids (DINK), the vendor or manufacturer may advertise on television in the evening when members of the household may be home after work. Alternately, where the optimum Purchaser may be stay-at-home moms, the vendor may advertise on television during the day or during family programming. Similarly, the vendor may tailor descriptions of the Products to the Purchaser, wherein the description may emphasize features most attractive to Purchasers within the optimum demographic.

Where a vendor may have a brick and mortar location, the vendor may design and structure the layout and atmosphere of the store based on preferences of the Purchasers. As a comparative example, a DINK Purchaser may be more likely to enter and buy from stores with neutral pallets, highly-organized layouts, and well-dressed salespeople; whereas a stay-at-home mom may be more likely to enter and buy from a store that is conducive to children, highlights bargains, and provides Products for multiple people within their household.

In some aspects, at 1550, the correlation data between Emotional Qualifier values of a Product or Product line and Emotional Motivator values of Purchasers may be transmitted to a research and development department. At 1551, research and development tactics and goals may be generated based on said correlation. In some embodiments, the recommendations generated at 1551 may provide a detailed description of how each attribute of the Product contributes to the values of each Emotional Qualifier, which may allow for targeted development.

A manufacturer may focus on developing the attributes correlating to the Emotional Qualifier value most closely associated with the Emotional Motivator of the optimum Purchaser. Such tactics may increase interest in the Product within the optimum group of Purchasers. Alternatively, a manufacturer may develop a Product to broaden the interested groups of Purchasers, for example, by focusing on the attributes that align the least with Emotional Motivator values of Purchasers.

Examining the earlier examples described for steps at 1540 and 1541, a manufacturer or vendor may establish separate research and development tactics and goals for DINKs and stay-at-home moms. As an illustrative example, the Product may be a camera, wherein the optimum Purchaser group may comprise DINKs. The key attributes that may be appealing to DINKs may be the sleek, trendy design, small size, and wireless capabilities to instantly transfer pictures to other devices, such as a friend's smartphone. The attributes that may be least appealing to a stay-at-home mom may be a slow capture speed and low durability, which may not be as important to a DINK.

The vendor or manufacturer may have funds for development of one or two attributes, and the associations provided at 1550 may allow the manufacturer to make an informed decision about the tactic. The manufacturer may decide to refine the trendy design and wireless capabilities to increase the number of DINKs that may be interested in the camera. Alternatively, the manufacturer may decide to expand their demographic and focus on the capture speed, allowing stay-at-home moms to take clear pictures of their children playing sports.

### CONCLUSION

A number of embodiments of the present invention have been described. Nevertheless, it will be understood that various modifications may be made without departing from the spirit and scope of the invention. For example, various methods or equipment may be used to implement the process steps described herein or to create a device according to the inventive concepts provided above and further described in the claims. In addition, various integration of components, as well as software and firmware may be implemented. Accordingly, other embodiments are within the scope of the following claims.

What is claimed is:

1. A computerized apparatus for receiving advice related to a Purchase decision, the apparatus comprising:
a communications network access device for accessing a server in logical communication with a communications network; and
executable software stored on the communications network access device and executable on demand, the software operative with the communications network access device to cause the network access device to:
receive a Purchaser interface for making selections which indicate emotional motivators of the Purchaser;
transmit one or more selected indications of emotional motivators;
receive a Purchaser interface for inputting a selection of a type of product or service the Purchaser is interested in; and
receive a display descriptive of one or more Products determined to be satisfactory to the Purchaser based upon emotional motivators associated with the Purchaser, wherein the emotional motivators associated with the Purchaser are determined based upon the transmitted indications of emotional motivators.

2. The apparatus of claim 1 wherein the software is additionally operative to receive a discount artifact entitling the Purchaser to a discounted price for the one or more Products determined to be satisfactory to the Purchaser.

3. The apparatus of claim 2 wherein the software is additionally operative to receive a link to a virtual point of purchase for the one or more of the Products determined to be satisfactory to the Purchaser based upon emotional motivators associated with the Purchaser.

4. The apparatus of claim 2 wherein the software is additionally operative to receive a link to a geographically local point of purchase for one or more of the Products determined to be satisfactory to the Purchaser based upon emotional motivators associated with the Purchaser.

5. The apparatus of claim 1 wherein the software is additionally operative to receive a Purchaser interactive display comprising a description of emotional motivators associated with the Purchaser.

6. The apparatus of claim 1 wherein the software is additionally operative to display a history of Purchase transactions completed by the Purchaser.

7. The apparatus of claim 1 wherein the software is additionally operative to display a history of inputs comprising indications of emotional motivators associated with the Purchaser.

8. The apparatus of claim 1 wherein the software is additionally operative to display an indication of how well a software engine designed to quantify emotional motivators is aware of Purchaser preferences based upon emotional motivators.

9. The apparatus of claim 1 wherein the software is additionally operative to indicate to the Purchaser which emotional motivators are associated with the Purchaser.

10. The apparatus of claim 1 wherein the software is additionally operative to indicate to the Purchaser which emotional motivators are associated with a Product chosen by the Purchaser.

11. A computerized apparatus for providing advice related to a Purchase decision, the apparatus comprising:
a computer server in logical communication with a communications network; and
executable software stored on the computer server and executable on demand, the software operative with the communications network access device to cause the server to:
transmit a Purchaser interface for making selections which indicate emotional motivators of the Purchaser;
receive one or more indications of emotional motivators to be associated with a Purchaser;
transmit a Purchaser interface for receiving a selection of a type of Product or Service the Purchaser is interested in;
associate one or more Products or Services with the Purchaser based upon the received indications of emotional motivators; and
transmit a display descriptive of one or more Products determined to be satisfactory to the Purchaser based upon emotional motivators associated with the Purchaser, wherein the emotional motivators associated with the Purchaser are determined based upon the transmitted indications of emotional motivators.

12. The apparatus of claim 11 wherein the software is additionally operative to transmit a discount artifact entitling the Purchaser to a discounted price for the one or more Products determined to be satisfactory to the Purchaser.

13. The apparatus of claim 12 wherein the software is additionally operative to transmit a link to a virtual point of purchase for the one or more of the Products determined to be satisfactory to the Purchaser based upon emotional motivators associated with the Purchaser.

14. The apparatus of claim 12 wherein the software is additionally operative to receive a link to a geographically local point of purchase for one or more of the Products determined to be satisfactory to the Purchaser based upon emotional motivators associated with the Purchaser.

15. The apparatus of claim 11 wherein the software is additionally operative to transmit a Purchaser interactive display comprising a description of emotional motivators associated with the Purchaser.

16. The apparatus of claim 11 wherein the software is additionally operative to transmit a history of Purchase transactions completed by the Purchaser.

17. The apparatus of claim 11 wherein the software is additionally operative to transmit a history of inputs comprising indications of emotional motivators associated with the Purchaser.

18. The apparatus of claim 11 wherein the software is additionally operative to transmit an indication of how well a software engine designed to quantify emotional motivators is aware of Purchaser preferences based upon emotional motivators.

19. The apparatus of claim 11 wherein the software is additionally operative to transmit an indication to the Purchaser specifying which emotional motivators are associated with the Purchaser.

20. The apparatus of claim 11 wherein the software is additionally operative to indicate to the Purchaser which emotional motivators are associated with a Product chosen by the Purchaser.
